(19) United States
(12) Patent Application Publication
(10) Pub. No.: US 2024/0267860 A1
(43) Pub. Date: Aug. 8, 2024

(54) METHODS PERFORMED BY NODES, AND NODES

(71) Applicant: Samsung Electronics Co., Ltd., Suwon-si (KR)

(72) Inventors: Weiwei WANG, Beijing (CN); Hong WANG, Beijing (CN); Lixiang XU, Beijing (CN)

(21) Appl. No.: 18/429,921

(22) Filed: Feb. 1, 2024

(30) Foreign Application Priority Data
Feb. 3, 2023 (CN) 202310129164.3
Jul. 27, 2023 (CN) 202310936987.7
Sep. 26, 2023 (CN) 202311254402.X

(51) Int. Cl. H04W 56/00; H04W 24/10; H04W 74/0833; H04W 80/02

(52) U.S. Cl. CPC H04W 56/0015; H04W 24/10; H04W 56/0045; H04W 74/0833; H04W 80/02

(57) ABSTRACT

A method performed by a first node in a wireless communication system is provided. The method includes receiving, from a base station, a configuration message including layer 1/layer 2 (L1/L2) triggered mobility (LTM) candidate information associated with a LTM candidate cell, wherein the LTM candidate information includes first information on an early uplink (UL) synchronization procedure; performing the early UL synchronization procedure with the LTM candidate cell based on the LTM candidate information; performing a L1 measurement on the LTM candidate cell; and transmitting, to the base station, a report message for the L1 measurement.

### CROSS-REFERENCE TO RELATED APPLICATION(S)

This application is based on and claims priority under 35 U.S.C. § 119(a) of a Chinese patent application number 202310129164.3, filed on Feb. 3, 2023, in the Chinese Intellectual Property Office, of a Chinese patent application number 202310936987.7, filed on Jul. 27, 2023, and of a Chinese patent application number 202311254402.X, filed on Sep. 26, 2023, in the Chinese Intellectual Property Office, the disclosure of each of which is incorporated by reference herein in its entirety.

### BACKGROUND

### 1. Field

The disclosure relates to a field of communication. More particularly, the disclosure relates to a method performed by nodes, and nodes.

### 2. Description of Related Art

In order to meet an increasing demand for wireless data communication services since a deployment of fourth generation (4G) communication system, efforts have been made to develop an improved fifth generation (5G) or pre-5G communication system. Therefore, the 5G or pre-5G communication system is also called “beyond 4G network” or “post long term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by nodes, and nodes.

Additional aspects will be set forth in part in the description which follows and, in part, will be apparent from the description, or may be learned by practice of the presented embodiments.

In accordance with an aspect of the disclosure, a method performed by a first node in a wireless communication system is provided. The method includes receiving, by the first node, from a first network node a first message for triggering the first node to acquire synchronization information of at least one candidate cell in a serving cell (or a source cell), acquiring, by the first node from one of a serving cell or the at least one candidate cell, the synchronization information of the at least one candidate cell or acquiring, by the first node, first uplink resource information for indicating a resource used for uplink transmission in the at least one candidate cell, and receiving, by the first node, a second message for indicating the first node to access a cell in the at least one candidate cell.

In some implementations, in the method performed by the first node, the synchronization information may be included in the second message.

In some implementations, the method performed by the first node further includes receiving a message for configuring at least one candidate cell and configuration information for accessing the at least one candidate cell for the first node.

In some implementations, the method performed by the first node further includes transmitting, by the first node, a first signal to at least one candidate cell, wherein, the first node may determine to transmit the first signal according to at least one of following a cell indicated by the first message for triggering the first node to acquire the synchronization information of the at least one candidate cell is a cell configured with first synchronization-related indication information among the at least one candidate cell, the first message for triggering the first node to acquire the synchronization information of the at least one candidate cell indicates that acquisition of the synchronization information is triggered by a command, third synchronization-related indication information in the first message for triggering the first node to acquire the synchronization information of the at least one candidate cell indicates that acquisition of the synchronization information is triggered by a command, random access signal indication information in the first message for triggering the first node to acquire the synchronization information of the at least one candidate cell indicates the first signal.

In some implementations, the method performed by the first node further includes starting a window for acquiring the synchronization information, wherein, when one or more of following is satisfied, the window for acquiring the synchronization information can be started the first node receives a command to trigger acquisition of the synchronization information, the first node transmits a first signal to the at least one candidate cell, the first node receives indication information to start the window, the first node receives a handover command, the first node waits for a certain time after transmitting the first signal to the at least one candidate cell.

In some implementations, the method performed by the first node further includes stopping the window after one or more of following is satisfied synchronization information is received from at least one candidate cell or serving cell, the first node transmits a first signal, and the first node receives a signaling that triggers transmission of the first signal.

In some implementations, the method performed by the first node further includes determining a cell that receives the synchronization information of the at least one candidate cell according to at least one of following an indication from a network side, a type of the cell, or whether the acquisition of the synchronization information is triggered.

In some implementations, the method performed by the first node further includes performing at least one of following after accessing the cell deleting synchronization information of other cells, reserving the synchronization information of the other cells until the synchronization information is invalid, or reserving the synchronization information of the other cells according to the indication from the network side.

In accordance with another aspect of the disclosure, a method performed by a first network node in a wireless communication system is provided. The method includes transmitting, by the first network node to a first node a first message for triggering the first node to acquire synchronization information of at least one candidate cell, so that the first node acquires the synchronization information of the at least one candidate cell from a serving cell or the at least one candidate cell, and transmitting, by the first network node, the synchronization information or first uplink resource information for indicating a resource used by the first node for uplink transmission in the at least one candidate cell to the first node, after the first node acquires the synchronization information, transmitting, by the first network node to the first node a second message for indicating the first node to access a cell in the at least one candidate cell.

In some implementations, in the method performed by the first network node, the second message includes the synchronization information of the at least one candidate cell.

In some implementations, the method performed by the first network node further includes transmitting to the first node a message for configuring at least one candidate cell and configuration information for accessing the at least one candidate cell for the first node, the message includes at least one of first cell indication information for indicating at least one candidate cell to be accessed by the first node, first configuration identity information for indicating configuration of the at least one candidate cell, first configuration information for indicating configuration information required to acquire the synchronization information of the at least one candidate cell, first report indication information for indicating information that the first node needs to report, first synchronization information acquisition-related indication information for indicating a manner for the first node to acquire the synchronization information, first waiting time indication information for indicating waiting time required for the first node to acquire the synchronization information, first window indication information for indicating a length of a window in which the first node receives the synchronization information, or first storage-related indication information for indicating a cell whose the synchronization information needs to be stored by the first node.

In some implementations, in the method performed by the first network node, the first cell indication information includes at least one of first cell identity information, first synchronization-related indication information for indicating a manner for triggering acquisition of the synchronization information, or first cell type information.

In some implementations, in the method performed by the first network node, the first configuration information contains configuration information required for the first node to transmit a random access signal to the at least one candidate cell after receiving the first message in the serving cell (or the source cell) before receiving a cell handover command. The first configuration information includes at least one of first random access signal-related configuration information for indicating configuration information of a random access signal transmitted/sent by the first node, first resource indication information for indicating a resource used by the random access signal transmitted/sent by the first node, or first offset information for indicating a time offset of the serving cell with at least one candidate cell of the first node.

In some implementations, in the method performed by the first network node, the first synchronization information acquisition-related indication information includes at least one of first enabling indication information for indicating whether the first node needs to acquire the synchronization information, first serving cell indication, first candidate cell indication, or first cell identity indication for indicating an identity of a cell for acquiring the synchronization information.

In some implementations, in the method performed by the first network node, the first storage-related indication information includes at least one of first removal-related indication information for indicating a cell to which synchronization information that needs to be removed belongs, first reservation-related indication information for indicating a cell to which synchronization information that needs to be reserved belongs, or first cell number information for indicating a number of cells to which the synchronization information that needs to be reserved belongs.

In some implementations, in the method performed by the first network node, the first random access signal-related configuration information includes at least one of first random access signal indication information for indicating a random access signal used when the first node acquires synchronization information of a candidate cell before receiving a handover command, second random access signal indication information for indicating a random access signal used by the first node when accessing a candidate cell, or third random access signal indication information for indicating a random access signal irrelevant to whether the first node receives the handover command or a trigger signaling.

In some implementations, in the method performed by the first network node, the first resource indication information includes at least one of first associated signal indication information or first resource configuration information.

In some implementations, in the method performed by the first network node, the first message for triggering the first node to acquire synchronization information of at least one candidate cell includes at least one of first random access signal-related configuration information for indicating configuration information of a random access signal transmitted/sent by the first node, third synchronization information acquisition-related indication information for indicating a manner for the first node to acquire the synchronization information, third waiting time indication information for indicating waiting time required for the first node to acquire the synchronization information, third window indication information for indicating a length of a window for the first node to receive the synchronization information, or third storage-related indication information for indicating a cell to which the synchronization information that needs to be stored by the first node belongs.

In some implementations, in the method performed by the first network node, the first random access signal-related configuration information includes at least one of third cell identity information for indicating an identity of a cell to which the random access signal transmitted/sent by the first node is directed, third cell type information, third synchronization-related indication information for indicating a manner for triggering acquisition of the synchronization information, random access signal indication information, third resource indication information for indicating a resource used by the random access signal transmitted/sent by the first node, or third resource configuration indication information for indicating configuration of a resource for transmitting the random access signal by the first node.

In some implementations, in the method performed by the first network node, the third synchronization information acquisition-related indication information includes at least one of third enabling indication information for indicating whether the first node needs to acquire the synchronization information, third serving cell indication, third candidate cell indication, or third cell identity indication for indicating an identity of a cell that acquires the synchronization information.

In some implementations, in the method performed by the first network node, the third storage-related indication information includes at least one of second removal-related indication information for indicating a cell to which synchronization information that needs to be removed belongs, second reservation-related indication information for indicating a cell to which synchronization information that needs to be reserved belongs, or second cell number information for indicating a number of cells whose synchronization information needs to be reserved by the first node.

In some implementations, in the method performed by the first network node, the message for transmitting synchronization information to the first node includes at least one of first synchronization information for indicating uplink synchronization information of the first node, first applicable information for indicating an applicable cell or cell group, or first identity information for indicating a random access signal transmitted/sent by the first node.

In some implementations, in the method performed by the first network node, the first uplink resource information includes at least one of multiple uplink resource indication information for indicating whether multiple uplink resources are configured for the first node, first interval indication information for indicating an interval between adjacent uplink resources, first number information for indicating a number of uplink resources, or first period information for indicating a period of the uplink resources.

In some implementations, the method performed by the first network node further includes receiving a fourth message from the first node, wherein, the fourth message includes at least one of a message for providing a measurement result of the first node, a first signal for acquiring synchronization information of at least one candidate cell, a message for reporting synchronization information acquired by the first node, or a message for notifying completion of a handover of the first node.

In some implementations, in the method performed by the first network node, the message for providing the measurement result of the first node includes at least one of first measurement result information, first downlink synchronization-related information, or first uplink synchronization-related information.

In some implementations, in the method performed by the first network node, the first measurement result information includes at least one of time offset information, signal quality information, or signal strength information.

In some implementations, in the method performed by the first network node, the first uplink synchronization-related information includes at least one of first uplink synchronization indication information, first synchronization cell indication information, first time indication information for indicating remaining time for which the uplink synchronization information is valid, or second time indication information for indicating remaining time from a resource for transmitting uplink data.

In some implementations, in the method performed by the first network node, the message for notifying the completion of the handover of the first node includes at least one of first access cell indication information, first synchronization completion-related indication information for indicating a cell whose synchronization information has been acquired by the first node, or first synchronization execution-related indication information for indicating a cell to which the first node has transmitted/sent the random access signal.

In some implementations, the method performed by the first network node further includes transmitting a third message to a second network node, wherein, the third message includes at least one of a message for providing configuration information of at least one candidate cell of the first node, a message for indicating configuration information for the first node at a source node of a handover, or a message for indicating configuration information for the first node at a target node of the handover.

In some implementations, in the method performed by the first network node, the message for providing configuration information of at least one candidate cell of the first node includes at least one of second cell indication information for indicating at least one candidate cell to be accessed by the first node, second configuration identity information for indicating configuration of at least one candidate cell, second configuration information for indicating configuration information required by the first node in a process of acquiring uplink synchronization information in advance (early) or configuration information required by the first node in a process of acquiring uplink synchronization information through random access, second report indication information for indicating information that the first node needs to report, second synchronization information acquisition-related indication information for indicating a manner for the first node to acquire the synchronization information, second waiting time indication information for indicating waiting time required for the first node to acquire the synchronization information, second window indication information for indicating a length of a window in which the first node receives the synchronization information, second storage-related indication information for indicating a cell to which the synchronization information stored by the first node belongs, or second interval indication information for indicating a length of a window in which a handover command is transmitted/sent.

In some implementations, in the method performed by the first network node, the second cell indication information includes at least one of second cell identity information, second synchronization-related indication information, or second cell type information.

In some implementations, in the method performed by the first network node, the second configuration information includes at least one of second random access signal-related configuration information, second resource indication information, second resource configuration information, or second offset information.

In some implementations, in the method performed by the first network node, the second report indication information includes at least one of downlink synchronization information or uplink synchronization information.

In some implementations, in the method performed by the first network node, the second synchronization information acquisition-related indication information includes at least one of second enabling indication information, second serving cell indication, second candidate cell indication, or second cell identity indication.

In some implementations, in the method performed by the first network node, the message for indicating the configuration information for the first node at the source node of the handover includes at least one of first synchronization-related indication information for indicating a manner for triggering the first node to acquire synchronization information of at least one candidate cell, first waiting time indication information for indicating waiting time required for the first node to acquire the synchronization information, first window indication information for indicating a length of a window in which the first node receives the synchronization information, fifth synchronization-related indication information for indicating a cell to which the synchronization information stored by the first node belongs, fourth interval indication information for indicating a length of a window in which a handover command is transmitted/sent, or first command transmission indication information for indicating that the handover command has been transmitted/sent to the first node.

In some implementations, in the method performed by the first network node, the message for indicating the configuration information for the first node at the target node of the handover includes at least one of first access configuration information for indicating configuration information required to access at least one candidate cell, first waiting time indication information for indicating waiting time required for the first node to acquire the synchronization information, first window indication information for indicating a length of a window in which the first node receives the synchronization information, sixth synchronization-related indication information for indicating a cell to which the synchronization information stored by the first node belongs, fifth interval indication information for indicating a length of a window in which the handover command is expected to be transmitted/sent, or first response information.

In accordance with another aspect of the disclosure, a method performed by a second network node in a wireless communication system is provided. The method includes receiving, by the second network node, a first message from a first network node, wherein, the first message includes information related to synchronization of the first node with at least one candidate cell, and the first message includes at least one of a message for providing configuration information of at least one candidate cell of the first node, a message for indicating configuration information for the first node at a source node of a handover, or a message for indicating configuration information for the first node at a target node of the handover.

In accordance with another aspect of the disclosure, a first node is provided. The first node includes a transceiver for transmitting and receiving a signal, memory, and one or more processors communicatively coupled to the transceiver and the memory, wherein the memory store one or more computer programs including computer-executable instructions that, when executed by the one or more processors, cause the first node to receive from a first network node a first message for triggering the first node to acquire synchronization information of at least one candidate cell in a serving cell or a source cell, acquire from one of the serving cell or the at least one candidate cell, the synchronization information of the at least one candidate cell or acquire first uplink resource information for indicating a resource used for uplink transmission in the at least one candidate cell, and receive a second message for indicating the first node to access a cell in the at least one candidate cell.

In accordance with another aspect of the disclosure, a first network node is provided. The first network node includes a transceiver for transmitting and receiving a signal, memory, and one or more processors communicatively coupled to the transceiver and the memory, wherein the memory store one or more computer programs including computer-executable instructions that, when executed by the one or more processors, cause the first network node to transmit to a first node a first message for triggering the first node to acquire synchronization information of at least one candidate cell, so that the first node acquires the synchronization information of the at least one candidate cell from a serving cell or the at least one candidate cell, transmit at least one of the synchronization information or first uplink resource information for indicating a resource used by the first node for uplink transmission in the at least one candidate cell to the first node, and after the first node acquires the synchronization information, transmit to the first node a second message for indicating the first node to access a cell in the at least one candidate cell.

In accordance with another aspect of the disclosure, one or more non-transitory computer-readable storage media storing one or more computer programs including computer-executable instructions that, when executed by one or more processors of a first node, cause the first node to perform operations are provided. The operations include receiving, by the first node, from a first network node a first message for triggering the first node to acquire synchronization information of at least one candidate cell in a serving cell or a source cell, acquiring, by the first node from one of the serving cell or the at least one candidate cell, the synchronization information of the at least one candidate cell or acquiring first uplink resource information for indicating a resource used for uplink transmission in the at least one candidate cell, and receiving by the first node, a second message for indicating the first node to access a cell in the at least one candidate cell.

In accordance with another aspect of the disclosure, a method performed by a user equipment (UE) in a wireless communication system is provided. The method includes receiving, from a base station, a configuration message including layer 1/layer 2 (L1/L2) triggered mobility (LTM) candidate information associated with a LTM candidate cell, wherein the LTM candidate information includes first information on an early uplink (UL) synchronization procedure; performing the early UL synchronization procedure with the LTM candidate cell based on the LTM candidate information; performing a L1 measurement on the LTM candidate cell; and transmitting, to the base station, a report message for the L1 measurement.

In accordance with another aspect of the disclosure, a method performed by a base station in a wireless communication system is provided. The method includes transmitting, to a user equipment (UE), a configuration message including layer 1/layer 2 (L1/L2) triggered mobility (LTM) candidate information associated with a LTM candidate cell, wherein the LTM candidate information includes first information on an early uplink (UL) synchronization procedure; receiving, from the UE, a random access preamble based on the LTM candidate information; and receiving, from the UE, a report message for a L1 measurement.

In accordance with another aspect of the disclosure, a terminal in a wireless communication system is provided. The terminal comprising: a transceiver; and a controller configured to: receive, from a base station via the transceiver, a configuration message including layer 1/layer 2 (L1/L2) triggered mobility (LTM) candidate information associated with a LTM candidate cell, wherein the LTM candidate information includes first information on an early uplink (UL) synchronization procedure, perform the early UL synchronization procedure with the LTM candidate cell based on the LTM candidate information, perform a L1 measurement on the LTM candidate cell, and transmit, to the base station via the transceiver, a report message for the L1 measurement.

In accordance with another aspect of the disclosure, a base station in a wireless communication system is provided. The terminal comprising: a transceiver; and a controller configured to: transmit, to a user equipment (UE) via the transceiver, a configuration message including layer 1/layer 2 (L1/L2) triggered mobility (LTM) candidate information associated with a LTM candidate cell, wherein the LTM candidate information includes first information on an early uplink (UL) synchronization procedure, receive, from the UE via the transceiver, a random access preamble based on the LTM candidate information, and receive, from the UE via the transceiver, a report message for a L1 measurement.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture of system architecture evolution (SAE) according to an embodiment of the disclosure;

FIG. 2 is a system architecture according to an embodiment of the disclosure;

FIG. 3 is a flowchart of an example process for reducing communication interruption of a first node during a handover process according to an embodiment of the disclosure;

FIG. 4 is a flowchart of a process for configuring a first node according to an embodiment of the disclosure;

FIG. 5 is a flowchart of a triggering process for a first node to acquire synchronization information according to an embodiment of the disclosure;

FIG. 6 is a flowchart of a synchronization information acquisition process according to an embodiment of the disclosure;

FIG. 7 is a flowchart of a handover process of a first node according to an embodiment of the disclosure;

FIG. 8 is a flowchart of an interaction process between network nodes according to an embodiment of the disclosure;

FIG. 9 is a block diagram of a node according to an embodiment of the disclosure; and

FIG. 10 is a block diagram of a user equipment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” includes A, may include B, or includes both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth© chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

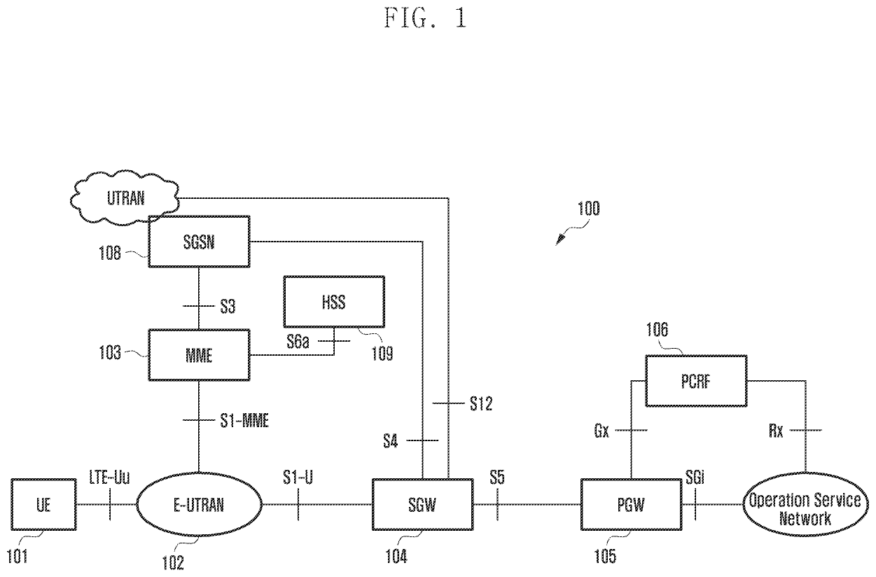

FIGS. 1 to 10 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is a system architecture of system architecture evolution (SAE) according to an embodiment of the disclosure.

Referring to FIG. 1, in a system architecture 100, user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, and the like, and may be in the same physical entity as the SGW 104. A policy and charging rules function entity (PCRF) 106 provides quality of service (QoS) policies and charging criteria. A serving general packet radio service (GPRS) support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, and the like.

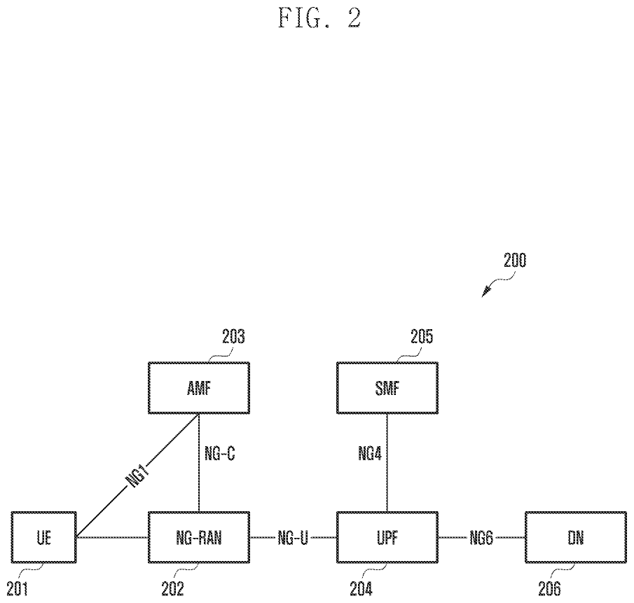

FIG. 2 is a system architecture according to an embodiment of the disclosure. Other embodiments of the system architecture can be used without departing from the scope of the disclosure.

Referring to FIG. 2, in a system architecture 200, user equipment (UE) 201 is a terminal device for receiving data. A next generation radio access network (NG-RAN) 202 is a radio access network, which includes a base station (a gNB or an eNB connected to 5G core network (5GC), and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity (SMF) 205 is responsible for session management. A data network (DN) 206 includes, for example, services of operators, access of Internet and service of third parties.

In a mobile network, the user equipment may hand over between different cells. A major problem caused by a handover is that the user equipment will experience a communication interruption during this process. main reasons for the interruption are that the user equipment needs to perform measurements for a long time; before handover, the network side needs to perform signaling interaction between different nodes to determine a target cell and a configuration of the target cell, and then transmit a handover command to the user equipment; thereafter, the user equipment needs to perform uplink and downlink synchronizations with the network, and during this process, it takes a long time for the user equipment to switch cells, which further affects the performance of the user equipment during the mobility procedure.

Before specific contents are introduced, some assumptions and some definitions of the disclosure are given below.
Message names in the disclosure are merely examples, and other message names may also be used.
Words such as “first” and “second” and so on included in the message names in the disclosure are merely used for distinguishing one message from another message, but do not denote the execution order.
In the disclosure, detailed description of operations unrelated to the disclosure is omitted.
In the disclosure, steps in various processes may be combined with each other for execution, or may be executed separately. The execution operations of various processes are merely possible operations, other possible execution operations and/or orders are not excluded.
In the disclosure, a base station may be a sixth generation (6G) base station, a 5G base station (such as a gNB, an ng-eNB), or may be a 4G base station (such as an eNB), or may be other types of access nodes.
In the disclosure, when a cell accessed by a user equipment changes from one cell to another, this behavior can be called a handover or a cell switch. In the following description, the handover and cell switch have the same meaning.
In the disclosure, synchronization information may include at least one of following information:
Downlink synchronization information
Uplink synchronization information, such as timing advance (TA) information

Nodes involved in the disclosure include:
A first node, which is a user terminal device, wherein the device may be a mobile phone, or a relay node.
A second node, which is a central unit of a base station, or a control plane portion of the central unit of the base station.
A third node, which is a distributed unit (DU) of the base station. In one example, the node is a distributed unit where a source cell of the first node is located during the mobility procedure. In another example, the node is a distributed unit where a target cell of the first node is located during the mobility procedure. When the target cell and the source cell are in the same distributed unit, the third node is the distributed unit serving the source cell and the target cell.
A fourth node, which is a base station. In one example, the node is the base station where the source cell of the first node is located during the mobility procedure.
A fifth node, which is a central unit of a base station, or a control plane portion of the central unit of the base station. When the first node moves between base stations, the fifth node is the node where the target cell is located.
A sixth node, which is a distributed unit of a base station. When the first node moves between different distributed units, the node is a distributed unit serving the target cell, and the above-mentioned third node is a distributed unit serving the source cell. When the first node moves between different distributed units in the same base station, both the above-mentioned third node and the sixth node are connected to the above-mentioned second node; when the first node moves between different distributed units in different base stations, the above-mentioned third node and the sixth node are respectively connected to the above-mentioned second node and fifth node.
A seventh node, which is a base station. In one example, the node is a base station where the target cell of the first node is located during the mobility procedure.

The base stations involved in the above-mentioned second to seventh nodes can respectively be any of the following types (other types that can be used for user terminal to access are not excluded):
LTE base station
5G base station
6G base station
Non-Terrestrial Network (NTN) base station
High Altitude Platform Station (HAPS)
Drone base station
WI-FI access point

During the mobility procedure, a user equipment will start a handover (a cell switch) according to a signaling on the network side. In order to speed up the handover process of the user equipment, the signaling on the network side can be a signaling from a lower layer (a Layer 1 signaling, such as a physical layer signaling, downlink control information (DCI); a layer 2 signaling, such as a medium access control (MAC) layer signaling, a MAC control element (MAC-CE)). After receiving the signaling, the user equipment still needs to synchronize with the target cell before data transmission can be performed through the target cell. This synchronization process will cause communication interruption during the handover process of the user equipment. Therefore, how to help the user equipment reduce communication interruption during the handover process is an urgent problem to be solved.

The user equipment may synchronize with at least one configured candidate cell (or acquire synchronization time information, such as timing advance information) before receiving the above-mentioned lower layer signaling. In this way, the user equipment can quickly access the target cell and communicate with the target cell after receiving the above-mentioned lower layer signaling, thereby avoiding interruption of data communication during the mobility procedure of the user equipment.

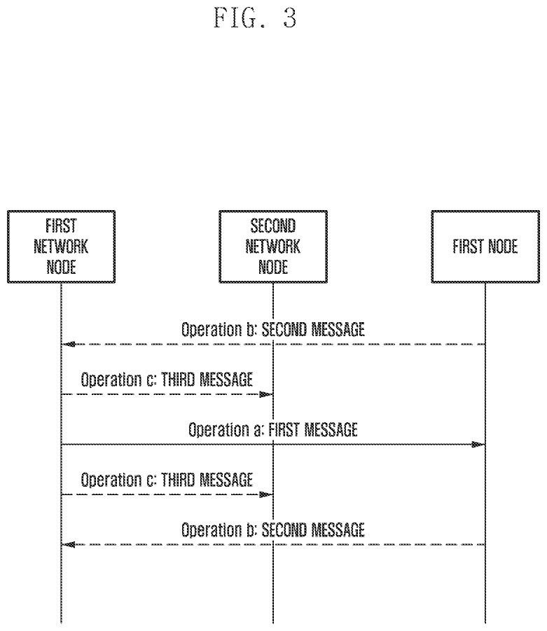

The disclosure includes the following process, as shown in FIG. 3.

FIG. 3 a flowchart of an example process for reducing communication interruption of a first node during handover, according to an embodiment of the disclosure.

Referring to FIG. 3, it should be noted that the combinations of the following operations are given in conjunction with the various processes in FIGS. 3 to 8 below, and those skilled in the art should understand that the combinations of the following operations that have been given are not exhaustive, and respective processes and/or various operations in the respective processes described herein can be combined arbitrarily as desired, and all such combinations are considered within the scope of the disclosure.

Operation a: a first network node transmits a first message to the first node, and the first message may have at least one of following examples:
First configuration message, as in operation 1-1 below
First command message, as in operation 1-3 below
First response message, as in operation 1-5 below
Second command message, as in operation 1-7 below

Operation b: the first node transmits a second message to the first network node, and the second message may have following examples:
First report message, as in operation 1-2 below
First signal, as in operation 1-4 below
Second report message, as in operation 1-6 below
First notification message, as in operation 1-8 below

This operation can occur before or after the operation a.

Operation c: the first network node transmits (directly or through other nodes) a third message to a second network node, and the third message may have following examples:
Second configuration message, as in operation 1-0 below, then the first network node and the second network node are the second node and the third node respectively
Third configuration message, as in operation 1-9 below, then the first network node and the second network node are the third node and the sixth node respectively
Fourth configuration message, as in operation 1-10 below, then the first network node and the second network node are the sixth node and the third node respectively

This operation can occur before or after the operation a.

The above-mentioned first network node may be any one of the second node to the seventh node, and the above-mentioned second network node is a node different from the first network node.

The processes and/or operations involved in the messages appearing in the above operations are given below. The serial numbers of the following operations do not represent the order in which the operations are executed, and the following operations can be executed separately or in combination with each other.

1) A Configuration Process of the First Node (this Process can be Performed Before and/or at the Same Time as the Handover of the First Node)

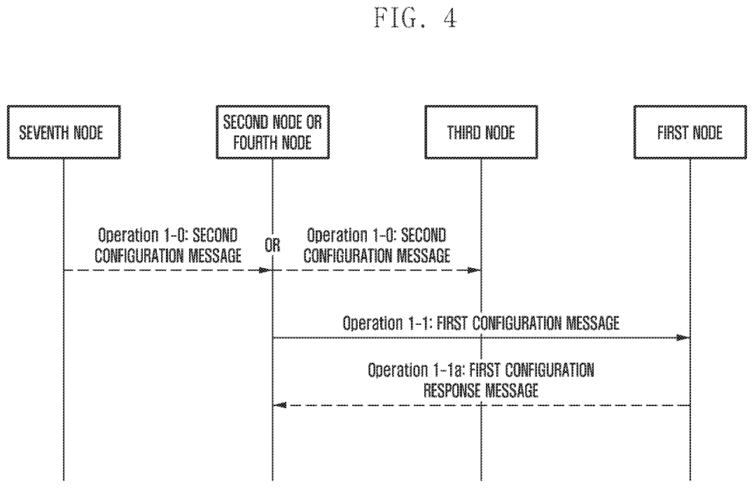

FIG. 4 is a flowchart of a process for configuring a first node according to an embodiment of the disclosure.

In order to configure the handover of the first node, the network side needs to configure the first node, and the configuration may include the following operations, as shown in FIG. 4:

Referring to FIG. 4, operation 1-1: the second node or the fourth node transmits a first configuration message to the first node. A function of the message is to configure at least one candidate cell and configuration information for accessing the at least one candidate cell for the first node, so that the first node accesses a target cell (the target cell may be one of the at least one candidate cell, and hereinafter, the target cell and the candidate cell may be used interchangeably). The message is related to synchronization of the first node and the at least one candidate cell, thereby speeding up the handover process. A beneficial effect of the first configuration message is to help the first node acquire the configuration for accessing the target cell, thereby reducing interruption in the access process. When the above-mentioned first configuration message is transmitted/sent to the first node through the second node, the second node will transmit the first configuration message to the first node through a third node. The above-mentioned first configuration message may include at least one of following information:
First cell indication information, which indicates information of one or more target cells or candidate cells accessed by the first node. For a cell, the information may include at least one of following information:
First cell identity information, such as a Physical Cell Identity (PCI), a New Radio Cell Global Identifier (NCGI), an Evolved-Universal Terrestrial Radio Access Network (E-UTRAN) cell global identifier (ECGI), cell index information, and the like. The cell indicated by the information is a target cell or candidate cell of the first node. In one embodiment, the target cell or candidate cell is a candidate target cell for handover by the first node. In another embodiment, the cell is a candidate cell for the first node to perform L1/L2 triggered mobility (LTM). Further, the information may also include the cell index information, and the identity information of the cell can be obtained according to this information
First synchronization-related indication information, which indicates a manner for triggering acquisition of synchronization information (such as uplink synchronization information, e.g., timing advance information) of the cell identified by the above “first cell identity information”. In an example, the manner indicated by the indication information is that the first node triggers the acquisition of the synchronization information of the cell identified by the above “first cell identity information” according to the signaling of its serving cell, for example, acquisition of synchronization information triggered by a physical downlink control channel (PDCCH) order. In one embodiment, the signaling that triggers the acquisition of synchronization information is a PDCCH order (that is, the PDCCH order triggers the acquisition of synchronization information, and the synchronization information may be timing advance information). Further, the PDCCH order may be transmitted/sent to the first node before the first node receives the handover command (the handover command is a command instructing the first node to switch to the cell identified by the above “first cell identity information). In one example, the “first synchronization-related indication information” is provided separately for the target cell or the candidate cell, that is, the first node has different manners for triggering acquisition of the synchronization information with respect to different cells (e.g., with respect to a target cell or a candidate cell configured with the above-described “first synchronization-related indication information”, the first node may acquire the synchronization information through triggering by the PDCCH order, otherwise, the first node cannot acquire the synchronization information through triggering by the PDCCH order); in another example, the “first synchronization-related indication information” is targeted to all cells included in the above-described “first cell indication information”. A beneficial effect of the information is that: the first node may acquire the synchronization information of the target cell or the candidate cell in advance, thereby reducing interruption time during the first node handover process
First cell type information, which indicates a type of a cell indicated by the above-described “first cell identity information”, for example, whether it is located in the same distributed unit as the serving cell (source cell) of the first node (e.g., intra-DU cell), whether it is located in a different distributed unit from the serving cell (source cell) of the first node (e.g., inter-DU cell), and further, the first node may also determine the behavior for receiving cell synchronization information according to the information, or the information is used for indicating the behavior of the first node for receiving cell synchronization information. An example of the behavior of the first node after receiving the information is that the first node may determine the cell receiving the synchronization information according to the information; if the cell type indicated by the information is intra-DU cell, then the first node will receive synchronization information in the current serving cell; if the cell type indicated by the information is inter-DU cell, then the first node will receive synchronization information in the target cell or the candidate cell; or, if the cell type indicated by the information is inter-DU cell, then the first node will receive synchronization information in the current serving cell; if the cell type indicated by the information is intra-DU cell, then the first node will receive synchronization information in the target cell or the candidate cell.
First configuration identity information, for example, a configuration ID, which indicates a configuration of the cell identified by the above-described “first cell identity information”, further, the configuration is configuration information required for data transmission by the first node within the cell identified by the above-described “first cell identity information”
First configuration information, which includes the configuration information required for the first node to acquire the synchronization information (e.g., uplink synchronization information, timing advance information) of the cell identified by the above-described “first cell identity information”. In one example, the first configuration information only includes one set of configuration information required for the first node to acquire the synchronization information (e.g., uplink synchronization information, timing advance information) of the cell identified by the above-described “first cell identity information”. In another example, the first configuration information includes at least two sets of configuration information required for the first node to acquire the synchronization information (e.g., uplink synchronization information, timing advance information) of the cell identified by the above-described “first cell identity information”. In one implementation, one set in the two sets is used to acquire the uplink synchronization information in advance (Early UL synchronization), and the other set is used to acquire synchronization information through a random access process (RACH based UL synchronization). For each set of configuration information, the information may include at least one of the following information:
First random access signal-related configuration information, which indicates configuration information of the random access signal transmitted/sent by the first node; in one example, the random access signal may be a preamble. The information may include at least one of the following information:
First random access signal indication information, which indicates the random access signal used by the first node when acquiring synchronization information (e.g., uplink synchronization information, timing advance information) of the target cell or the candidate cell; in one example, the information is index information of the random access signal, for example, a preamble index. The random access signal indicated by the information is transmitted/sent to the target cell or the candidate cell; further, transmitting of the random access signal is triggered by signaling from the serving cell of the first node (e.g., the PDCCH order). In one implementation, the random access signal is a random access signal transmitted/sent by the first node to the candidate cell before receiving a command to handover to the candidate cell (e.g., an LTM command, an RRCReconfiguration, an RRC handover command); in another implementation, the random access signal indicated by the information is triggered by a non-handover command (e.g., the PDCCH order). In addition, the random access signal indicated by the information may be specifically used for the first node to acquire synchronization information (e.g., uplink synchronization information, timing advance information) of the target cell or the candidate cell in the source cell (or the serving cell). After the target cell or the candidate cell receives the random access signal indicated by the indication information, the serving node of the target cell or the candidate cell may be informed that the random access signal is triggered by the signaling of the source cell or the serving cell where the first node is located, or that the random access signal is used for the first node to acquire synchronization information of the target cell or the candidate cell within the source cell or the serving cell. In one example, the random access signal indicated by the first random access signal indication information is a random access signal used by the first node when performing cell handover or cell switch process based on a non-random access process. For example, the first random access signal is used to acquire the timing advance information, and then the handover is performed directly (no more random access is required) after receiving the command to handover to the candidate cell (e.g., a LTM command, a RRCReconfiguration, a RRC handover command).
Second random access signal indication information, which indicates a random access signal used by the first node when accessing the candidate cell; in one example, the information is the index information of the preamble, for example, a preamble index. In one implementation, the random access signal indicated by the information is a random access signal transmitted/sent by the first node to the candidate cell after receiving a command to handover to the candidate cell (e.g., an LTM command, an RRCReconfiguration, an RRC handover command). In another implementation, the random access signal indicated by the information is triggered by a handover command (e.g., an LTM command, an RRCReconfiguration, an RRC handover command). The random access signal indicated by the information is different from the random access signal indicated by the above-described “first random access signal indication information”. That is to say, if the first node is to transmit a random access signal to the candidate cell, the random access signals used before and after receiving the command to handover to the candidate cell will be different (e.g., a random access signal indicated by the “first random access signal indication information” is transmitted/sent before receiving the handover command, and a random access signal indicated by the “second random access signal indication information” is transmitted/sent after receiving the handover command), or, the first node may determine the random access signal to be used according to different signaling received thereby (e.g., if the first node receives a PDCCH order or a PDCCH order including target cell or candidate cell identity information, the first node will transmit the random access signal indicated by the above-described “first random access signal indication information”; if the first node receives a handover command, the first node will transmit the random access signal indicated by the above-described “second random access signal indication information”, further, the above-described command of “PDCCH order” includes information of the target cell or the candidate cell, and the above-described “handover command” includes information of the target cell or the candidate cell). After configuring the “first random access signal indication information” and “second random access signal indication information” as described above, the network side (e.g., the node receiving the random access signal) will determine subsequent behavior according to the different types of received random access signals (referring to description in “Behavior on the network side after receiving the random access signal” below for specific description). In one example, the random access signal indicated by the second random access signal indication information is a random access signal used by the first node when performing a cell handover or cell switch process based on a random access process.
Third random access signal indication information, which indicates a random access signal transmitted/sent by the first node to the candidate cell. The random access signal is not related to whether the first node has received the handover command or the trigger signaling received by the first node, that is to say, the random access signal transmitted/sent by the first node will not differ depending on whether the handover command has been received or whether the trigger signaling is different
First resource indication information, which is used to determine resources (e.g., a Random Access Channel Occasion (RACH Occasion) and/or beam) used by the random access signal (e.g., a preamble signal) transmitted/sent by the first node. The transmitted/sent random access signal may be one or more of the random access signals indicated by the above-described “first random access signal-related configuration information”, and the information may include at least one of the following information:
Random access configuration indication information, which indicates configuration parameters for random access, such as prach-configurationIndex (physical random access channel configuration index)
First associated signal indication information, which indicates a signal associated with the resource of the transmitted/sent random access signal; in one example, if the signal is a synchronization signal (e.g., a Synchronization Signal Block (SSB)), then the indication information is an SSB (Synchronization signal SS/Physical Broadcast Channel PBCH) index; in another example, if the signal is a Channel State Information Reference Signal (CSI-RS), then the indication information is a CSI-RS Index. Further, the information also indicates a beam used by the first node when transmitting the random access signal
First resource configuration information, which indicates configuration of the resource for transmitting the random access signal; in one example, the configuration of the resource is a RACH occasion and/or a beam configuration
Carrier indication information, i.e., an indication of a carrier where the resource is located, such as a normal uplink carrier, a supplementary uplink carrier

In one implementation, information included in the above-mentioned “first random access signal-related configuration information” includes RACH-ConfigGeneric (generic random access configuration information) and/or RACH-ConfigDedicated (dedicated random access configuration information). The above RACH-ConfigGeneric includes at least one of the following information: prach-configurationIndex, a target power for receiving a preamble at the network receiver side, preambleReceivedTargetPower, the maximum number of times that the preamble is transmitted, premableTransMax, a ramping operation of the transmission power of the preamble, powerRampingStep, and the size of the random access response window, ra-ResponseWindow, and the like. The above RACH-ConfigDedicated (this information can be used for random access of a normal uplink carrier, or can be used for random access of a supplementary uplink carrier) includes at least one of the following information: contention free random access-related configuration information, occasion information (corresponding to the above “first resource configuration information”), rach-ConfigGeneric, the number of SSBs corresponding to each RACH occasion, ssb-perRACH-occasion, resource configuration information (such as a mask index for random access resource selection, a physical random access channel mask index), a corresponding SSB or CRI-RS index, SSB/CSIRS-index, and a preamble index, ra-PreambleIndex (corresponding to the above “first random access signal indication information”, or “second random access signal indication information”, or “third random access signal indication information”)
First offset information, which indicates time offset of two different cells, for example, a super frame number offset, a subframe offset, a slot offset, a reference signal time difference (RSTD), and the like. The above-described two different cells may respectively be the serving cell (or the source cell) and the candidate cell of the first node
First report indication information, which indicates information that the first node needs to report. After receiving the information, the first node may select information to report according to the information; in one example, the information to report may be transmitted/sent through a “first report message” below. The information reported by the first node may help the nodes on the network side determine the state of the first node, thereby accelerating handover of the first node. The information to report indicated by the information may be at least one of the following information:
Downlink synchronization information
Uplink synchronization information, or indication information for acquiring uplink synchronization information (e.g., timing advance)
First synchronization information acquisition-related indication information, which indicates a mode in which the first node acquires the synchronization information (e.g., the uplink synchronization information); further, acquisition of the synchronization information targeted by the indication information refers to acquisition of the synchronization information by the first node triggered through the PDCCH order, or acquisition of the synchronization information before the first node receives the handover command to handover to the target cell, or acquisition of the synchronization information based on the PDCCH order before the first node receives the handover command to handover to the target cell. A beneficial effect of the information is that: the information helps the first node to acquire synchronization information of the target cell or the candidate cell, thereby reducing communication interruptions during handover. The information may include at least one of the following information:
First enabling indication information, which indicates whether the first node needs and/or is enabled to acquire the synchronization information (e.g., the uplink synchronization information, the timing advance information)
First serving cell indication, which indicates whether to acquire the synchronization information through the serving cell of the first node
First candidate cell indication, which indicates whether to acquire the synchronization information through the target cell or the candidate cell
First cell identity indication: which indicates the identity of the cell for acquiring the synchronization information
First waiting time indication information, which indicates waiting time required for the first node to acquire the synchronization information. In one example, after transmitting the random access signal, the first node needs to wait for the time indicated by the indication information before acquiring the synchronization information (e.g., the timing advance information); in another example, after transmitting the random access signal, the first node needs to wait for the time indicated by the indication information before starting to receive the synchronization information (e.g., after waiting for the time indicated by the indication information, the first node starts a window to receive the synchronization information, for example, a ra-ResponseWindow, and receives downlink information in the window, for example, Random Access Response (RAR); and the information includes the synchronization information, for example, the timing advance information). After receiving the information, the first node will wait for a period of time before receiving the synchronization information. During the period of time, the first node may continue data transmission (e.g., data transmission with the serving cell). A beneficial effect of the information is to reduce communication interruptions during the process of the first node acquiring the synchronization information, and improve throughput of the user equipment
First window indication information, which indicates a length of a window for the first node to receive the synchronization information (e.g., the uplink synchronization information, the timing advance information), that is, the first node will only receive the synchronization information within the time length indicated by the information. A beneficial effect of the information is to reduce communication interruptions during the process of the first node acquiring the synchronization information, and improve throughput of the user equipment
First storage-related indication information, which indicates the cell to which the synchronization information required to be stored by the first node belongs, or the number of cells. A beneficial effect of the information is to help the first node maintain synchronization information for a limited number of cells, reduce requirements for device capabilities thereof, and simplify design of the first node. The information may include at least one of the following information:
First removal-related indication information, which indicates one or more cells to which the synchronization information (e.g., the uplink synchronization information, the timing advance information) that needs to be removed belongs, for example, the cell identity information. After the first node receives the information, the first node will remove the synchronization information of the cell indicated by the information
First reservation-related indication information, which indicates one or more cells to which the synchronization information (e.g., timing advance information) that needs to be reserved by the first node belongs, for example, the cell identity information
First cell number information, which indicates the number of cells to which the synchronization information that needs to be reserved by the first node belongs

Optionally, after the above-described operation 1-1, operation 1-1a may further be included, that is, transmitting, by the first node, a first configuration response message to the second node or the fourth node.

The above-described “first configuration message” is an RRC message, for example, an RRCReconfiguration message, or other messages. Further, optionally, the above-described “first configuration message” may be transmitted/sent after operation 1-0 below.

Operation 1-0: transmitting, by the second node, a second configuration message to the third node (or transmitting, by the seventh node, a second configuration message to the fourth node), the message serves to provide configuration information for the candidate cell or the target cell of the first node. A beneficial effect for the third node or the fourth node receiving the message is that: on the one hand, the first node may be configured to measure the candidate cell or the target cell, and on the other hand, the first node may also be configured to access the target cell or the candidate cell (e.g., configuring appropriate resources for the first node so that the first node acquires the uplink synchronization information of the candidate cell). The message may include at least one of the following information:
Second cell indication information, which indicates the information of one or more target cells or candidate cells accessed by the first node. With respect to a cell, the information may include at least one of the following information:
Second cell identity information, for example, a PCI, a NCGI, an ECGI, and cell index information, and the like, a cell indicated by this information is the target cell or the candidate cell of the first node; in one embodiment, the target cell or the candidate cell is a candidate target cell for the first node's handover, and in another embodiment, the cell is a candidate cell for the first node to perform L1/L2 triggered mobility (LTM). Further, the information may also include the cell index information, according to which, the cell identity information may be known
Second synchronization-related indication information, which indicates a manner for triggering acquisition of the synchronization information (e.g., the uplink synchronization information, for example, the timing advance information) of the cell identified by the above-described “second cell identity information”; and the third node will trigger the first node to acquire the synchronization information according to the information. In one example, the manner indicated by the indication information is that: the first node triggers acquisition of the synchronization information of the cell identified by the above-described “second cell identity information” according to the signaling of the serving cell thereof, and then the third node will transmit the signaling to the first node. In one implementation, the signaling that triggers acquisition of the synchronization information is the PDCCH order (i.e. the PDCCH order triggers acquisition of the synchronization information, and the synchronization information may be the timing advance information); further, the PDCCH order may be transmitted/sent to the first node before the first node receives a handover command (the handover command is a command that instructs the first node to handover to the cell identified by the above-described “second cell identity information”). After receiving the “second synchronization-related indication information”, the third node may transmit a signaling (e.g., a PDCCH order) to the first node to trigger the first node to acquire the synchronization information of the target cell or the candidate cell targeted by the above-described “second synchronization-related indication information”; in one example, the “second synchronization-related indication information” is provided separately for the target cell or the candidate cell, that is, the first node has different manners for triggering acquisition of the synchronization information with respect to different cells (e.g., with respect to the target cell or the candidate cell configured with the above-described “second synchronization-related indication information”, the first node may acquire the synchronization information through triggering by the PDCCH order, otherwise, the first node cannot acquire the synchronization information through triggering by the PDCCH order); in another example, the “second synchronization-related indication information” is targeted to all cells included in the above-described “second cell indication information”. A beneficial effect of the information is that the third node may configure the first node to acquire the synchronization information of the target cell or the candidate cell in advance, thereby reducing interruption time during the first node handover process
Second cell type information, which indicates the type of a cell indicated by the above-described “second cell identity information”, for example, whether it is located in the same distributed unit as the serving cell (the source cell) of the first node (e.g., intra-DU cell), whether it is located in a different distributed unit from the serving cell (the source cell) of the first node (e.g., inter-DU cell)
Second configuration identity information, for example, a configuration ID, which indicates configuration of the cell identified by the above-described “second cell identity information”, further, the configuration may be configuration information required for data transmission by the first node
Second configuration information, which includes the configuration information required for the first node to transmit a random access signal within a cell identified by the above-described “second cell identity information”; the information may include at least one of the following information (for specific descriptions of respective items of information, description in the above-described “first configuration information” may be referred to):
Second random access signal-related configuration information, which indicates configuration information of the random access signal transmitted/sent by the first node; in one example, the random access signal may be a preamble. The information may include at least one of the following information (for information included in the information, please refer to the above “first random access signal-related configuration information”):
   First random access signal indication information
   Second random access signal indication information
   Third random access signal indication information
Second resource indication information. For information included in the information, please refer to the above “first resource indication information”.
Second resource configuration information. For information included in the information, please refer to the above “first resource configuration information”.
Second offset information. For information included in the information, please refer to the above “first offset information”.

In one example, information included in the above “second configuration information” is configuration information used by the first node in the process of acquiring uplink synchronization information (such as timing advance information) in advance (early). The configuration information can be named as early UL synchronization configuration information, early TA acquisition configuration information, configuration information for a cell handover without random access (RACH-less cell switch configuration, i.e. a cell switch with RACH process omitted), and the like. In one implementation, the above-mentioned “process of acquiring uplink synchronization information (such as timing advance information) in advance” is when the first node transmits the random access signal to the cell identified by the above “second cell identity information” after receiving the first indication information (such as a PDCCH order, which indicates the cell to which the first node transmits the random access signal) from the serving cell, and then acquires the uplink synchronization information of the cell identified by the above “second cell identity information” through the signaling (such as the above-mentioned LTM command, RRCReconfiguration, RRC handover command) of the serving cell. In another example, the information included in the above “second configuration information” is configuration information used by the first node to acquire synchronization information (such as timing advance information) through a random access process (or contention free random access process). The configuration information may be named as RACH-based configuration, contention free random access (CFRA) configuration, and the like. In one implementation, the above “random access process” is when the first node transmits the random access signal to the cell identified by the above “second cell identity information” after receiving the second indication information (such as the above-mentioned LTM command, RRCReconfiguration, RRC handover command) from the serving cell, and then acquires uplink synchronization information of the cell from the cell identified by the above “second cell identity information”. In another example, the information included in the above “second configuration information” includes not only the above “configuration information used by the first node in the process of acquiring uplink synchronization information (such as timing advance information) in advance”, but also the above “configuration information used by the first node to acquire synchronization information through the random access process”. After receiving the information, the third node may use different configuration information according to different implementations for the first node to acquire the uplink synchronization information to trigger the first node to transmit the random access signal. When the first node adopts the “process of acquiring uplink synchronization information in advance”, the third node will indicate transmission of the random access signal through the PDCCH order; when the first node adopts the “random access process to acquire synchronization information”, the third node will indicate the transmission of the random access signal through the above-mentioned LTM command/RRCReconfiguration/RRC handover command. Based on the description in the above-mentioned “first configuration information”, the above “configuration information used by the first node in the process of acquiring uplink synchronization information (such as timing advance information) in advance (early)” and/or the above “configuration information used by the first node to acquire synchronization information through the random access process” may include at least one of the following information:
Frequency domain indication information, such as normal carrier indication information, supplementary uplink carrier indication information, BWP indication information, and the like.
Time alignment timer information, which is used to indicate a valid time of uplink synchronization information (such as timing advance)
RACH-ConfigGeneric (generic random access configuration information), which includes at least one of the following information: prach-configurationIndex, a target power for receiving a preamble at the network receiver side, preambleReceivedTargetPower, the maximum number of times that the preamble is transmitted, preambleTransMax, a ramping operation of the transmission power of the preamble, powerRampingStep, and the size of the random access response window, ra-ResponseWindow, and the like.
RACH-ConfigDedicated (dedicated random access configuration information), which can be used for random access of the normal uplink carrier, or can be used for random access of the supplementary uplink carrier. The information includes at least one of the following information: contention free random access-related configuration information, occasion information (corresponding to the above “first resource configuration information”), rach-ConfigGeneric, the number of SSBs corresponding to each RACH occasion, ssb-perRACH-occassion, resource configuration information (such as the mask index for random access resource selection, the physical random access channel mask index), the corresponding SSB or CSI-RS index, SSB/CSIRS-index, and the preamble index, ra-PreambleIndex (corresponding to the above “first random access signal indication information”, or “second random access signal indication information”, or “third random access signal indication information”)

After receiving the above-described “second configuration information”, the third node or the fourth node may be informed of a location of a time-frequency resource that the first node transmits a random access signal (the signal may be triggered by the second node through a signaling (e.g., the PDCCH order)) to the candidate cell, so as to avoid scheduling the first node at the location (e.g., scheduling the first node for data transmission in the source cell) and avoid causing unnecessary resource waste
Second report indication information, which indicates the information that the first node needs to report. After receiving the information, the third node or the fourth node may be informed of information content reported by the first node. The information reported by the first node may help the nodes on the network side determine the state of the first node, thereby accelerating handover of the first node. The reported information indicated by the information may be at least one of the following information:
Downlink synchronization information
Uplink synchronization information, or indication information for acquiring uplink synchronization information (e.g., timing advance)
Second synchronization information acquisition-related indication information, which indicates a manner for the first node to acquire the synchronization information (e.g., the uplink synchronization information); further, acquisition of the synchronization information targeted by the indication information refers to acquisition of the synchronization information by the first node triggered through the PDCCH order, or acquisition of the synchronization information before the first node receives the handover command to handover to the target cell, or acquisition of the synchronization information based on the PDCCH order before the first node receives the handover command to handover to the target cell. A beneficial effect of the information is that: the information helps the third node or the fourth node be informed of the mode in which the first node acquires the synchronization information of the target cell or the candidate cell, and then selects a scheduling occasion for the first node, so as to reduce communication interruptions during handover. The information may include at least one of the following information:
Second enabling indication information, which indicates whether the first node is enabled to acquire the synchronization information (e.g., the uplink synchronization information, the timing advance information), that is, whether the first node needs to and/or be enabled to receive the synchronization information
Second serving cell indication, which indicates whether to acquire the synchronization information through the serving cell of the first node
Second candidate cell indication, which indicates whether to acquire the synchronization information through the target cell or the candidate cell
Second cell identity indication: the information indicates the identity of the cell for acquiring the synchronization information
Second waiting time indication information, which indicates waiting time required for the first node to acquire the synchronization information. In one example, after transmitting the random access signal, the first node needs to wait for the time indicated by the indication information before acquiring the uplink synchronization information (e.g., the timing advance information); in another example, after transmitting the random access signal, the first node needs to wait for the time indicated by the indication information before starting to receive the uplink synchronization information (e.g., after waiting for the time indicated by the indication information, the first node starts a window to receive the synchronization information, for example, a ra-ResponseWindow, and receives downlink information in the window, for example, Random Access Response (RAR); and the information includes the uplink synchronization information, for example, the timing advance information). After receiving the information, the third node or the fourth node may be informed that the first node will wait for a period of time before receiving the synchronization information, and then may schedule the first node for data transmission (e.g., data transmission with the serving cell) within the period of time. A beneficial effect of the information is to reduce communication interruptions during the process of the first node acquiring the synchronization information, and improve throughput of the user equipment
Second window indication information, which indicates a length of a window in which the first node to receive the synchronization information (e.g., the uplink synchronization information, the timing advance information), that is, the first node will only receive the synchronization information within the time length indicated by the information. After receiving this information, the third node or fourth node will not schedule the first node in this window to ensure that the first node receives the synchronization information. A beneficial effect of the information is to ensure the first node acquires the synchronization information and to speed up the handover process
Second storage-related indication information, which indicates a cell to which the synchronization information stored by the first node belongs, for example, the cell identity information, or the number of cells. A beneficial effect of the information is that the third node or the fourth node is informed of the cell to which the synchronization information stored by the first node belongs, to further help the third node or the fourth node select an appropriate target cell for the first node, in order to accelerate handover of the first node. Further, the information may be transmitted/sent from the sixth node to the second node, from the sixth node to the fifth node, and then from the fifth node to the second node, or from the seventh node to the fourth node
Second storage-related capability indication information, which indicates the number of cells whose synchronization information can be stored by the first node. If the information is 5, then it means that the first node can store synchronization information of up to 5 cells. The stored synchronization information may be downlink synchronization information, uplink synchronization information, or uplink and downlink synchronization information. The indication information may indicate the number of cells for the downlink synchronization information, the uplink synchronization information, and the uplink and downlink synchronization information, respectively. After receiving this information, the third node or fourth node can determine how many cells' synchronization information the first node can be triggered to acquire in advance according to the information (such as the synchronization information that the first node is triggered to acquire before a handover command or an LTM command). Further, the indication information may be reported by the first node to the second node or seventh node, and then sent by the second node or seventh node to the third node or fourth node. A beneficial effect of the information is to help to determine the capability of the first node to acquire synchronization information in advance, select a suitable cell to allow the first node to acquire synchronization information of the target cell in advance, and reduce communication interruption during the handover process.
Second interval indication information, which indicates a length of a window for the third node and/or the fourth node to transmit handover commands, that is, the third node and/or the fourth node need to transmit handover commands to the first node within the window; further, the length of the window may also be used to help configure uplink resources used by the first node after accessing the target cell, for example, the uplink resources needs to be configured after the end of the window. A beneficial effect of the information is to help the network side determine an occasion for transmitting the handover commands, fully utilize the resources configured to the first node, and avoid resource waste

Optionally, after the above-described operation 1-0, operation 1-0a (not shown) may be further included, that is, transmitting, by the third node, a second configuration response message to the second node (or transmitting, by the fourth node, a second configuration response message to the seventh node), wherein, the message may include configuration information generated by the third node or the fourth node with respect to the first node.

When the above-described “second configuration message” is transmitted/sent from the second node to the third node, the message is a message on the F1 interface, for example, a UE Context Setup/Modification Request message. When the above-described “second configuration message” is transmitted/sent from the seventh node to the fourth node, the message is a message on the Xn interface, for example, a Handover Request Acknowledge message, or other messages.

2) Triggering Process for the First Node to Acquire Synchronization Information (the Process May be Executed Before and/or Simultaneously with Handover of the First Node)

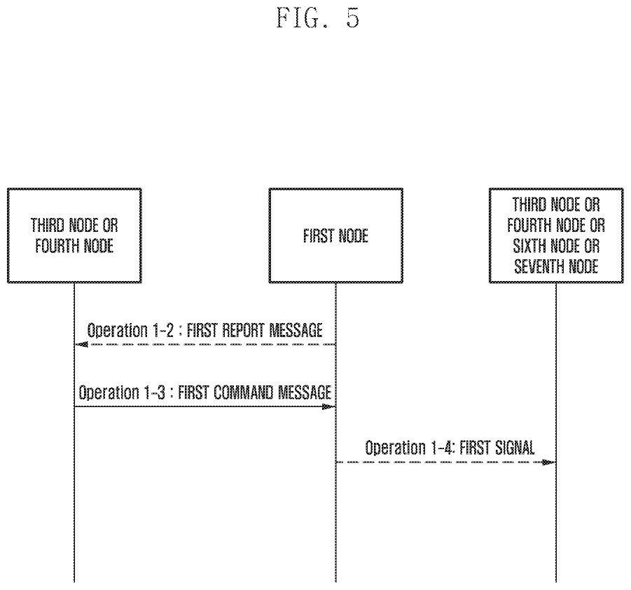

FIG. 5 is a flowchart of a triggering process for a first node to acquire synchronization information according to an embodiment of the disclosure.

In order to access a target cell, the first node may acquire synchronization information of the target cell in advance, that is, the serving cell of the first node may trigger the first node to acquire the synchronization information of the target cell. The process may include the following operations, as shown in FIG. 5:

Referring to FIG. 5, operation 1-2: optionally, transmitting, by the first node, a first report message to the third node or the fourth node, the message providing the measurement results or capability information of the first node, so that the second node (e.g., via the third node) or the fourth node determines signal transmission or cell access of the first node, for example, determine to which cell to transmit the signal (e.g., the random access signal, the preamble signal), and determine the target cell of the first node. The message may include at least one of the following information:
First measurement result information, which includes a measurement result of the first node on the candidate cell or the serving cell. A beneficial effect of the information is to help network nodes determine the target cell of the first node and ensure timely handover of the first node. The information may include at least one of the following information:
Time offset information, which indicates a time offset of two different cells, for example, a super frame number offset, a subframe offset, a slot offset, a reference signal time difference (RSTD), and the like. The above-described two different cells may respectively be the serving cell (or the source cell) and the candidate cell or the target cell of the first node
Signal quality and/or strength information, for example, Reference Signal Received Power (RSRP), L1-RSRP, Reference Signal Received Quality (RSRQ), L1-RSRQ, Received Signal Strength Indicator (RSSI), L1-RSSI, and the like.
Third storage-related capability indication information, which indicates the number of cells whose synchronization information can be stored by the first node. If the information is 5, then it means that the first node can store synchronization information of up to 5 cells. The stored synchronization information may be downlink synchronization information, uplink synchronization information, or uplink and downlink synchronization information. The indication information may indicate the number of cells for the downlink synchronization information, the uplink synchronization information, and the uplink and downlink synchronization information, respectively. After receiving this information, the third node or fourth node can determine how many cells' synchronization information the first node can be triggered to acquire in advance according to the information (such as the synchronization information that the first node is triggered to acquire before a handover command or an LTM command). Further, after the second node or fourth node receives the indication information, the second node may transmit the indication information to the third node, or the fourth node may transmit the indication information to the seventh node. A beneficial effect of the information is to help to determine the capability of the first node to acquire synchronization information in advance, select a suitable cell to allow the first node to acquire synchronization information of the target cell in advance, and reduce communication interruption during the handover process.
First downlink synchronization-related information, which indicates information related to downlink synchronization of the first node, for example, information of a cell with which the first node has completed downlink synchronization, or information of a cell to which the downlink synchronization information saved by the first node belongs. In one example, the information indicates the cell identity information. A beneficial effect of the information is to help the network side be informed of the downlink synchronization state of the first node, select the appropriate target cell, and accelerate handover of the first node
First uplink synchronization-related information, which indicates information related to uplink synchronization of the first node. A beneficial effect of the information is to help the network side be informed of the uplink synchronization state of the first node, select the appropriate target cell, and accelerate handover of the first node. The information may include at least one of the following information:
First uplink synchronization indication information, which indicates whether the first node has completed uplink synchronization, or whether the first node has acquired uplink synchronization information (e.g., timing advance information), or whether the uplink synchronization information becomes invalid after acquiring the information (e.g., after acquiring the timing advance information, a timer related to the timing advance information (e.g., a timing advance timer) expires, then the timing advance information becomes invalid. After receiving the information, the network side may be informed of the uplink synchronization state of the first node, so as to determine whether it is necessary to configure the first node to acquire more synchronization information. A beneficial effect of the information is to accelerate handover of the first node and reduce interruptions during the handover process
First synchronization cell indication information, which indicates information of a cell that has completed uplink synchronization with the first node, or information of a cell to which the uplink synchronization information acquired by the first node belongs. In one example, the information indicates the cell identity information. After receiving the information, the network side may select an appropriate cell as the target cell, for example, the cell whose synchronization information has been acquired as the target cell. A beneficial effect of the information is to help the network side select an appropriate target cell for handover, and reduce communication interruptions during the handover process
First time indication information, which indicates remaining time for the uplink synchronization information acquired by the first node to remain valid; in other words, after the time indicated by the information, the uplink synchronization information acquired by the first node will become invalid. After receiving the information, the network side may transmit a handover command to the first node within the time indicated by the information, to accelerate handover of the first node
Second time indication information, which indicates remaining time to a resource (e.g., a UL grant; in one example, the resource is an uplink resource assigned by the network side to the first node after the first node transmits a random access signal, for example, a UL grant included in RAR during the random access process) for the first node to transmit uplink data; in other words, after the time indicated by the information, there is a resource assigned to the first node for uplink data transmission; in one example, the uplink resource is a resource that the first node transmits uplink data in the target cell or the candidate cell. After receiving the information, the network side may determine when to transmit a handover command to the target cell or the candidate cell to the first node, for example, transmit a handover command to the first node within the time indicated by the information. A beneficial effect of the information is to help the network side determine the time when the first node needs to access the target cell or the candidate cell, avoid missing data transmission of the first node in the target cell or the candidate cell, and reduce resource waste

In one example, the information required to be included in the above-described “first report message” is determined by the first node itself, while in another example, the information required to be included in the above-described “first report message” is determined according to the “first report indication information” in operation 1-1 or the “second report indication information” in operation 1-0 as described above;

The above-described “first report message” may be a L1 layer message, for example, uplink control information (UCI), a MAC CE, an RRC message, or other types of messages.

Operation 1-3: transmitting, by the third node or the fourth node, a first command message to the first node, the message serves to trigger the first node to transmit a random access signal (e.g., a preamble signal) to at least one target cell or candidate cell; the signal serves to help the first node acquire uplink synchronization information (e.g., timing advance information) for at least one target cell or candidate cell; the first command message is transmitted/sent to the first node through the serving cell (or the source cell) of the first node; in one example, the at least one target cell or candidate cell may be a subset of at least one candidate cell configured in the above-described first configuration message. In one example, the message is a PDCCH order. The message may include at least one of the following information:
First random access signal-related configuration information, which indicates configuration information required by the first node to transmit the random access signal; and the information may include at least one of the following information:
Third cell identity information, which indicates an identity of a cell (or a candidate cell) to which the random access signal transmitted/sent by the first node is directed (or an index of the cell, or an index of the candidate cell)
Third cell type information, which indicates a type of the cell indicated by the above-described “third cell identity information”, for example, whether it is located in the same distributed unit as the serving cell (source cell) of the first node (e.g., intra-DU cell), whether it is located in a different distributed unit from the serving cell (source cell) of the first node (e.g., inter-DU cell), and further, the first node may also determine the behavior for receiving cell synchronization information according to the information, or the information is used for indicating the behavior of the first node for receiving cell synchronization information. In an example, after receiving the information, the first node may determine the cell for receiving the synchronization information (e.g., uplink synchronization information, the timing advance information) according to the information; if the information indicates an intra-DU cell, then the first node may acquire the synchronization information through the serving cell (or the source cell); if the information indicates an inter-DU cell, then the first node may acquire the synchronization information through the target cell or the candidate cell; if the information indicates an inter-DU cell, then the first node may acquire the synchronization information through the serving cell (or the source cell); if the information indicates an intra-DU cell, then the first node may acquire the synchronization information through the target cell or the candidate cell. A beneficial effect of the information is to help the first node determine how to acquire the synchronization information, which may accelerate synchronization of the first node and reduce communication interruptions during the handover process
Third synchronization-related indication information, which indicates a manner for triggering acquisition of the synchronization information (e.g., the uplink synchronization information, for example, the timing advance information) of the cell identified by the above-described “third cell identity information”; in one example, the manner indicated by the indication information is that: the first node triggers acquisition of the synchronization information of the cell identified by the above-described “third cell identity information” according to a signaling of the serving cell thereof. In one implementation, the signaling that triggers acquisition of the synchronization information is the PDCCH order (i.e. the PDCCH order triggers acquisition of the synchronization information, and the synchronization information may be the timing advance information); further, the PDCCH order may be transmitted/sent to the first node before the first node receives a handover command (the handover command is a command that indicates the first node to handover to a cell identified by the above-described “third cell identity information”). In one example, the “third synchronization-related indication information” is provided separately for the target cell or the candidate cell, that is, the first node has different manners for triggering acquisition of the synchronization information with respect to different cells (e.g., with respect to the target cell or the candidate cell configured with the above-described “third synchronization-related indication information”, the first node may acquire the synchronization information through triggering by the PDCCH order, otherwise, the first node cannot acquire the synchronization information through triggering by the PDCCH order); in another example, the “third synchronization-related indication information” is targeted to all cells included in the above-described “third cell identity information”. A beneficial effect of the information is that the first node may acquire the synchronization information of the target cell or the candidate cell in advance, thereby reducing interruption time during the first node handover process
Random access signal indication information, for example, indication information of a preamble signal, the preamble index; in one example, related configuration of the random access signal indicated by the information is transmitted/sent to the third node or the fourth node in advance through the above-described operations, for example, a random access signal indicated by the “first random access signal indication information” or the “second random access signal indication information” or the “third random access signal indication information” as described above transmitted/sent by the second node to the third node (or the by the seventh node to the fourth node). In one implementation, the third node or the fourth node will set the “random access signal indication information” according to the manner for triggering the first node to transmit a random access signal, for example, when transmitting the random access signal is triggered by a PDCCH order (in one example, the PDCCH order is transmitted/sent before transmitting a handover command to the first node), the random access signal indicated by the “random access signal indication information” is the signal indicated by the above-described “first random access signal indication information”; or when the “first command message” includes the above-described “third cell identity information”, the random access signal indicated by the “random access signal indication information” is the signal indicated by the above-described “first random access signal indication information”. A beneficial effect of the information is to help the first node select an appropriate random access signal for transmitting; and further, the transmitted/sent random access signal may help the network side determine how to provide synchronization information for the first node
Third resource indication information, which is used to determine resources (e.g., an RACH Occasion) used for the random access signal (e.g., a preamble signal) transmitted/sent by the first node; in one example, the information indicates a synchronization signal (e.g., a SSB) associated with the resource of the random access signal transmitted/sent, for example, a SSB (SS/PBCH) Index; in another example, the information indicates a CSI-RS associated with the resources of the random access signal transmitted/sent, for example, a CSI-RS Index; and further, the information also indicates a beam used by the first node when transmitting the random access signal
Third resource configuration indication information, which is used to determine a configuration of a resource for the first node to transmit the random access signal, for example, a configuration of RACH Occasion, for example, a Physical Random Access Channel Mask Index (PRACH Mask Index)
Third synchronization information acquisition-related indication information, which indicates a manner for the first node to acquire the synchronization information (e.g., the uplink synchronization information); further, acquisition of the synchronization information targeted by the indication information refers to acquisition of the synchronization information by the first node triggered through the PDCCH order, or acquisition of the synchronization information before the first node receives the handover command to handover to the target cell, or acquisition of the synchronization information based on the PDCCH order before the first node receives the handover command to handover to the target cell. A beneficial effect of the information is that: the information helps the first node acquire synchronization information of the target cell or the candidate cell, thereby reducing communication interruptions during handover. The information may include at least one of the following information:
Third enabling indication information, which indicates whether the first node needs and/or is enabled to acquire the synchronization information (e.g., the uplink synchronization information, the timing advance information)
Third serving cell indication, which indicates whether to acquire the synchronization information through the serving cell of the first node
Third candidate cell indication, which indicates whether to acquire the synchronization information through the target cell or the candidate cell
Third cell identity indication: the information indicates an identity of a cell for acquiring the synchronization information
Third waiting time indication information, which indicates waiting time required for the first node to acquire the synchronization information. In one implementation, the information indicates a specific length of time, while in another implementation, the information indicates a length of time pre-configured for the first node, the pre-configuration may be configured to the first node through other operations (e.g., pre-configured to the first node through the “first waiting time indication information” in the above-described operation 1-1). In one example, after transmitting the random access signal, the first node needs to wait for the time indicated by the indication information before acquiring the uplink synchronization information (e.g., the timing advance information); in another example, after transmitting the random access signal, the first node needs to wait for the time indicated by the indication information before starting to receive the uplink synchronization information (e.g., after waiting for the time indicated by the indication information, the first node starts a window to receive the uplink synchronization information, for example, a ra-ResponseWindow, and receives downlink information in the window, for example, Random Access Response (RAR); and the information includes the uplink synchronization information). After receiving the information, the first node will wait for a period of time before receiving the synchronization information; during the period of time, the first node may continue data transmission (e.g., data transmission with the serving cell). A beneficial effect of the information is to reduce communication interruptions during the process of the first node acquiring the synchronization information, and improve throughput of the user equipment
Third window indication information, which indicates a length of the window for the first node to receive the synchronization information (e.g., the uplink synchronization information, the timing advance information), that is, the first node will only receive the synchronization information within the time length indicated by the information. In one implementation, the information indicates a specific length of the window, while in another implementation, the information indicates a window length pre-configured for the first node, for example, a window length pre-configured through the “first window indication information” in the above-described operation 1-1. In one example, the window is a length of time for the first node to receive the uplink synchronization information (e.g., the timing advance information), that is, the first node will only receive the uplink synchronization information within the time length indicated by the window. A beneficial effect of the information is to reduce communication interruptions during the process of the first node acquiring the synchronization information, and improve throughput of the user equipment
Third storage-related indication information, which indicates a cell to which the synchronization information that needs to be stored by the first node belongs, or the number of cells. A beneficial effect of the information is to help the first node maintain synchronization information for a limited number of cells, reduce requirements for device capabilities thereof, and simplify design of the first node. The information may include at least one of the following information:
Second removal-related indication information, which indicates one or more cells to which the synchronization information (e.g., the uplink synchronization information, the timing advance information) that needs to be removed belongs, for example, the cell identity information. After the first node receives the information, the first node will remove the synchronization information of the cell indicated by the information
Second reservation-related indication information, which indicates one or more cells to which the synchronization information (e.g., timing advance information) that needs to be reserved by the first node belongs, for example, the cell identity information
Second cell number information, which indicates a number of cells to which the synchronization information that needs to be reserved by the first node belongs

The above-described “first command message” may be an L1 layer message, for example, the PDCCH order, or may also be a MAC CE, or may also be an RRC message, or may also be a newly defined message. After receiving the above-described “first command message”, the first node will determine transmitting of the random access signal according to the information in the message. Optionally, the process further includes the following operations:

Operation 1-4: transmitting, by the first node, a first signal to the third node or the fourth node, or the sixth node, or the seventh node; a cell to which the transmitted/sent first signal belongs is the target cell or the candidate cell. In one example, the signal is a random access signal (e.g., a preamble signal). In one embodiment, the first node may determine the random access signal to be transmitted/sent according to the above-described “first command message”; in another embodiment, the first node may determine the random access signal to be transmitted/sent according to the above-described “first configuration message”; and in another embodiment, the first node determines the random access signal to be transmitted/sent according to the above-described “first command message” and “first configuration message”.

### Behaviors of User Terminals for Transmitting Random Access Signals

When the first node is configured with a variety of different random access signals, for example, configured with different preambles, the first node will select an appropriate random access signal according to an occasion and/or configuration for transmitting the random access signal. For example, when the first node is configured with a preamble used specifically for the manner of synchronization information acquisition triggered by the PDCCH order (e.g., the preamble indicated by the above-described “first random access signal indication information”), the first node will determine the preamble used for transmitting and acquiring the synchronization information (the timing advance information) according to at least one of the following conditions:
The cell indicated by the “third cell identity information” in the above-described “first command message” is a cell configured with the above-described “first synchronization-related indication information” among the candidate cells indicated in the above-described “first configuration message”
The above-described “first command message” indicates that the first node acquires the synchronization information in the manner of PDCCH order triggering, for example, the above-described “first command message” is downlink control information carried by PDCCH
The “third synchronization-related indication information” in the above-described “first command message” indicates that the first node acquires the synchronization information in the manner of PDCCH order triggering
The “random access signal indication information” in the above-described “first command message” indicates a preamble required to be used by the first node
   Behavior of the Network Side after Receiving the Random Access Signal

After receiving the above-described “first signal”, the third node or the fourth node or the sixth node or the seventh node may also need to distinguish a type of the above-described “first signal”, and then determine subsequent behavior based on the type. Hereinafter, there is a given embodiment that a network side node (e.g., the third node or the fourth node or the sixth node or the seventh node) determines subsequent behavior according to the type of the “first signal” received:
When the above-described “first signal” is a random access signal specifically used for synchronization information acquisition (e.g., a random access signal triggered based on PDCCH order, or a random access signal transmitted/sent with respect to the candidate cell or the target cell before the first node receives a handover command, or a random access signal triggered based on the PDCCH order before the first node receives a handover command), that is, when the above-described “first signal” is the random access signal indicated by the above-described “first random access signal indication information”, or when the network side node is informed that the received random access signal is triggered by the PDCCH order (e.g., the random access signal transmitted/sent in the synchronization information acquisition process triggered by the PDCCH order), the network side node (e.g., the node that receives the random access signal transmitted/sent by the first node) will select at least one of the following behaviors:
Calculating the synchronization information required for the first node, for example, the timing advance information
Configuring an uplink resource (such as a UL grant), which are used by the first node to transmit uplink information. In one embodiment, the uplink information is used to notify successful access indication information (such as the following “first notification message”) after the first node accesses the target cell. Therefore, the uplink resource needs to be configured after the first node accesses the target cell. To achieve this purpose, in an example, the UL grant can be configured before the synchronization information (such as timing advance information) is about to be invalid, for example, it is configured at a position closer to the time when the synchronization information is about to be invalid, so that the first node can have a longer time to access the target cell, and then can use the uplink resources to transmit uplink information to the target cell, so as to notify that it has correctly accessed the target cell; in another example, the UL grant is configured at a position having a certain time interval (the interval can be pre-configured or determined by the network side node) from the time when the random access signal is transmitted/sent or received, so that the network side can transmit the handover command within this time interval to the first node so as to trigger the first node to access the target cell. Further, the time interval may be long enough to allow the first node to complete the access of the target cell; the time interval may be configured by other nodes (such as the sixth node, or the second node, or the seventh node, and the like) to the node (such as the third node or the fourth node above) where the serving cell (or candidate cell) of the first node is located, in order for it to decide when to transmit the handover command to the first node, or may be configured by other nodes (such as the third node, or the second node, or the fourth node) to the node (such as the sixth node or the seventh node) where the target cell or candidate cell for receiving the random access signal of the first node is located, in order for it to decide the allocation of uplink resources; in another example, multiple uplink resources can be configured, and the first node will select one of them to transmit uplink data
Transmitting a response message. An example of the response message is an RA Response message, which may include synchronization information and/or uplink resource configuration information. In an example, the response message may be transmitted/sent by the node (such as the sixth node or the seventh node) that receives the random access signal of the first node to the node (such as the third node or the fourth node) where the serving cell or the source cell of the first node is located; if it is transmitted/sent by the sixth node transmits to the third node, it can be transmitted/sent through the second node and/or the fifth node, and then it is transmitted/sent by the node (such as the third node or the fourth node) where the serving cell or the source cell of the first node is located to the first node. In another example, the response message may be directly transmitted/sent to the first node by a node (such as the third node or the fourth node or the sixth node or the seventh node) that receives the random access signal of the first node. In another example, the node (such as the sixth node or the seventh node) that receives the random access signal of the first node may transmit the above response message after receiving the indication information (e.g., which indicates that the handover command has been transmitted/sent to the first node, or indicates that the first node has received the handover command, or indicates that the first node has accessed the target cell or candidate cell) from other nodes (such as the third node or the fourth node).
When the above “first signal” is a random access signal indicated by the above “second random access signal indication information” or “third random access signal indication information”, the network side node (such as the node that received the random access signal transmitted/sent by the first node) will generate a response message and transmit it to the first node
   3) Synchronization Information Acquisition Process (this Process can be Executed Before and/or at the Same Time as the Handover of the First Node)

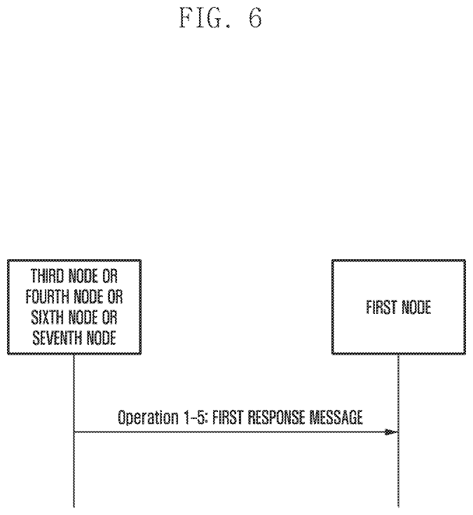

FIG. 6 is a flowchart of a synchronization information acquisition process according to an embodiment of the disclosure.

After transmitting the above “first signal”, the first node needs to obtain synchronization information from the network side, which includes following operations, as shown in FIG. 6:

Referring to FIG. 6, operation 1-5: the first node acquires the first response message from the third node or the fourth node or the sixth node or the seventh node. In one example, the first response message includes synchronization information of at least one candidate cell. In one example, if the first node acquires the first response message from the third node or the fourth node, then the first node acquires the first response message from the serving cell; in another example, if the first node acquires the first response message from the sixth node or the seventh node, then the first node acquires the first response message from the target cell or the candidate cell. The first response message may contain at least one of following information:
First synchronization information, which indicates the uplink synchronization information of the first node, such as timing advance information. Further, this information can also include valid time information of the synchronization information, that is to say, after the first node receives the information, the synchronization information is valid within the time indicated by the valid time information, otherwise, it becomes invalid synchronization information, and the first node cannot use this information as a reference for uplink synchronization
First uplink resource information, which indicates a resource used by the first node to transmit uplink data, such as a UL Grant. In one example, the resource indicated by this information is the resource used by the first node to transmit uplink data in the target cell (or candidate cell). Further, the uplink data may be a notification message transmitted/sent to a distributed unit or base station where the target cell is located after the first node accesses (is handed over to) the target cell (such as notifying successful access of the first node, or the following “first notification message”); further, the first uplink resource information may include multiple uplink resources (such as multiple UL Grants), and the multiple uplink resources can be used by the first node for transmitting uplink data. For example, the first node can select one of these resources to transmit the above notification message for notifying successful access. In this case, in addition to configuration information of each uplink resource (UL Grant), the above “first uplink resource information” may also include at least one of following information:
Multiple uplink resource indication information, which indicates whether multiple uplink resources (UL Grants) are configured for the first node
First interval indication information, which indicates a length of the interval between two adjacent uplink resources
First number information, which indicates the number information of uplink resources
First period information, which indicates the period of the uplink resources
First applicable information, which indicates identity information of the cell or cell group to which the above “first synchronization information” and/or “first uplink resource information” are applicable
First identity information, which is used to identify the random access signal transmitted/sent by the first node, such as a random access preamble ID (RAPID)

In an example, the above “first response message” may be a random access response message. The message may be transmitted/sent to the first node through different cells. In one implementation, it may be a RAR message included in a MAC CE, which is transmitted/sent by a cell that receives the random access signal transmitted/sent by the first node, such as a target cell or a candidate cell. In another implementation, it may be included in a MAC layer message (such as a MAC CE) or a PHY layer message (such as DCI) transmitted/sent by the serving cell (or source cell) of the first node. In one example, the above “first response message” is transmitted/sent before the handover command is transmitted/sent, and in another example, the above “first response message” is transmitted/sent through the handover command.

### Behavior of the First Node Determining Whether to Receive a Response Message

In an implementation, after the first node transmits a random access signal (such as a preamble) to the target cell or the candidate cell, the first node needs to determine whether to receive the above “first response message”. Several possible examples are given below:
In an example, the first node determines whether to receive the above “first response message” according to the “first synchronization information acquisition-related indication information” in the above “first configuration message”, if the “first synchronization information acquisition-related indication information” indicates that it needs and/or is enabled to acquire synchronization information, then the first node will receive the above “first response message”, otherwise, it will not receive
In an example, the first node determines whether to receive the above “first response message” according to the “third synchronization information acquisition-related indication information” in the above “first command message”, if the “third synchronization information acquisition-related indication information” indicates that it needs and/or is enabled to acquire synchronization information, then the first node will receive the above “first response message”, otherwise, it will not receive
In an example, the first node determines whether to receive the above “first response message” according to the manner for triggering of the random access signal. If the first node triggers the transmission of the random access signal according to the PDCCH order, it does not need to receive the above “first response message” separately, but can receive the above “first response message” through, for example, a handover command; otherwise, it needs to receive the above “first response message” separately; or the first node needs to receive the above “first response message” if the first node triggers transmitting of the random access signal according to the PDCCH order, otherwise, it does not need to receive the above “first response message”
In an example, the first node determines whether it needs to receive the above “first response message” according to the type of the cell where it transmits the random access signal. For example, when the above cell is an intra-DU cell, it needs to receive the above “first response message”, when the above cell is an inter-DU cell, it does not need to receive the above “first response message”; or when the above cell is an intra-DU cell, it does not need to receive the above “first response message”, when the above-mentioned cell is an inter-DU cell, it needs to receive the above-mentioned “first response message”.
   Behavior of the First Node Determining when to Receive a Response Message

In order to receive the above “first response message”, in an example, the first node may receive it within a window, for example, the first node will monitor PDCCH within the window (such as monitoring a PDCCH scrambled by the random access-radio network temporary identity (RNTI)/cell-radio network temporary identity (C-RNTI) of the first node) to obtain whether there is a “first response message” transmitted/sent to the node, if yes, the “first response message” is received.

In another implementation, after the first node transmits a random access signal (such as a preamble, a preamble triggered by a PDCCH order, a preamble for the target cell or candidate cell triggered by the PDCCH order of the serving cell or source cell, a preamble transmitted/sent during synchronization information acquisition triggered by the PDCCH order) to the target cell or the candidate cell, the first node needs to determine when to start receiving the “first response message”. Possible implementations are given below:
Implementation I: after the first node transmits a random access signal (such as a preamble) to the target cell or candidate cell, the first node will no longer receive the above “first response message”. In an example, after transmitting the random access signal, the first node does not start the window for receiving the “first response message”, such as an RA response window, so that the first node will not receive the above “first response message”.
Implementation II: after the first node transmits a random access signal (such as a preamble) to the target cell or candidate cell, the first node starts to receive the above “first response message”. In an example, after transmitting the random access signal, the first node starts a window for receiving the “first response message”, such as an RA response window, so that the first node will start to receive the above “first response message” (such as receiving by monitoring PDCCH, or receiving by monitoring PDCCH containing RA-RNTI information)
Implementation III: after the first node transmits a random access signal (such as a preamble) to the target cell or candidate cell, the first node starts to receive the above “first response message” after receiving an indication from the network side. In an example, after transmitting the random access signal, the first node starts a window for receiving the “first response message”, such as an RA response window, but the first node does not start receiving the above “first response message”, and it will only start to receive the above “first response message” when the above “window” has not ended (or is running) and after it receives an indication from the network side (such as receiving by monitoring PDCCH, or receiving by monitoring PDCCH containing RA-RNTI information). The “indication from the network side” may be indication information carried by DCI or a MAC CE (such as information indicating to start PDCCH monitoring, or information indicating to start receiving the above “first response message”), or handover command information (a LTM command, a RRC handover command, and the like), and further, the handover command information may also include information for indicating the first node to start receiving the “first response message” (e.g., information for indicating to start PDCCH monitoring). A network side entity that transmits the above indication information may be the above third node or the fourth node
Implementation IV: after the first node transmits a random access signal (such as a preamble) to the target cell or candidate cell, the first node starts the window for receiving the above “first response message” after receiving an indication from the network side, such as an RA response window, and start to receive the above “first response message” when the window has not ended (or running) (such as receiving by monitoring the PDCCH, or receiving by monitoring the PDCCH containing RA-RNTI information). The “indication from the network side” may be indication information carried by DCI or a MAC CE (such as information for indicating to start PDCCH monitoring, or information for indicating to start receiving the above “first response message”, starting a window to receive the above “first response message”), or may be a handover command information (such as a LTM command, a RRC handover command, and the like), and further, the handover command information may also include information for indicating the first node to start a window to receive the above “first response message”, and/or window size information. The network side entity that transmits the above indication information may be the above third node or the fourth node
Implementation V: after the first node transmits a random access signal (such as a preamble) to the target cell or candidate cell, the first node starts the window for receiving the above “first response message” after a certain period of time, such as an RA response window, and receives the above “first response message” (such as receiving by monitoring the PDCCH, or receiving by monitoring the PDCCH containing RA-RNTI information) when the window has not ended (or is running). The above “certain period of time” may be pre-configured to the first node by the network, such as configured to the first node through the “first waiting time indication information” in the “first configuration message” in the above operation 1-1, or may be configured to the first node through the “third waiting time indication information” in the “first command message” in the above operation 1-3
Implementation VI: after the first node transmits a random access signal (such as a preamble) to the target cell or candidate cell, the first node starts to receive the above “first response message” after a certain period of time. In an example, after transmitting the random access signal, the first node will start a window for receiving the above “first response message”, such as an RA response window, but the first node does not start to receive the above “first response message”, and it will start receiving after a certain period of time and when the window has not ended (or running) (such as receiving by monitoring the PDCCH, or receiving by monitoring the PDCCH containing RA-RNTI information). The above “certain period of time” may be pre-configured to the first node by the network, such as configured to the first node through the “first waiting time indication information” in the “first configuration message” in the above operation 1-1, or may be configured to the first node through the “third waiting time indication information” in the “first command message” in the above operation 1-3

In the above implementations, in order to determine when to start receiving the above “first response message”, the first node may need to receive the indication information from the network side. In one embodiment, the indication information may be transmitted/sent through the “first configuration message” in the above operation 1-1. In another embodiment, the indication information may be transmitted/sent through the “first command message” in the above operation 1-3. In another embodiment, the indication information may be transmitted/sent by a message different from the above “first configuration message” or “first command message”, for example, it may be a message after operation 1-1 or 1-3. In another embodiment, the indication information may be transmitted/sent through a handover command. The above “indication information from the network side” may be transmitted/sent through an RRC signaling, or a MAC CE, or DCI. In addition, the indication information from the network side may also include window size information, such as a size of the window (such as a RA-ResponseWindow, or a new window) for the first node to receive the above “first response message”. After receiving the information, the first node will receive the above “first response message” only when the window has not ended or is running.

### Behavior of the First Node Starting the Synchronization Information Receiving Window

The above embodiments also indicate different conditions for the first node to start a window (such as a ra-ResponseWindow, or a new window) for receiving the above “first response message”, that is, the first node will start the window only when one or more of following conditions are met:
Condition I: the first node receives a PDCCH order that triggers acquisition of synchronization information (such as timing advance information). In one example, the PDCCH order indicates configuration information for the first node to acquire synchronization information of a target cell or a candidate cell, and indicates the first node to transmit a random access signal (such as a preamble) to the target cell or candidate cell
Condition II: the first node transmits a random access signal (such as a preamble) to the target cell or candidate cell
Condition III: the first node receives indication information for starting the window. The indication information may be transmitted/sent by a base station or distributed unit where the serving cell of the first node is located, or may be transmitted/sent by a base station or distributed unit where the target cell or candidate cell of the first node is located
Condition IV: the first node receives a handover command from the network side (such as an LTM handover command or order, an RRC handover command, and the like), and further, the target cell indicated by the handover command is the cell to which the first node transmits the random access signal
Condition V: the first node waits for a certain period of time after transmitting the random access signal to the target cell or candidate cell. The “certain period of time” can be pre-configured

### Behavior of the First Node for Determining the Cell to Receive the Synchronization Information

In another implementation, after the first node transmits a random access signal (such as a preamble) to the target cell or the candidate cell, the first node needs to determine the cell to receive the above “first response message”. Specifically, the first node may determine the cell for receiving the above “first response message” through at least one of the following implementations:
Implementation I: the first node determines the cell for receiving the above “first response message” through an indication from the network side, for example, through the “first synchronization information acquisition-related indication information” in the “first configuration message” in the above operation 1-1, or through the “third synchronization information acquisition-related indication information” in the “first command message” in the above operation 1-3
Implementation II: the first node determines by the type of the cell, such as the cell type of the cell (target cell, or candidate cell) indicated in the “first configuration message” of the above operation 1-1 or the “first command message” of the above operation 1-3. Specifically, when the cell is an intra-DU, the first node can acquire it through the serving cell; or when the cell is an inter-DU, the first node can acquire it through the target cell or candidate cell; or when the cell is an inter-DU, the first node can acquire it through the serving cell, or when the cell is an intra-DU, the first node can acquire it through the target cell or candidate cell
Implementation III: the first node determines through whether the synchronization information acquisition process (such as the uplink synchronization information acquisition process triggered by the PDCCH order) is triggered. For example, when the first node acquires the timing advance information of the target cell or candidate cell through the synchronization information acquisition process triggered by the PDCCH order, the first node can receive the above “first response message” through the serving cell; otherwise, the first node acquires it through the target cell or candidate cell, or when the first node acquires the timing advance information of the target cell or the candidate cell through the synchronization information acquisition process triggered by the PDCCH order, the first node can receive the above “first response message” through the target cell or the candidate cell, otherwise, the first node acquires the “first response message” through the serving cell
   Behavior for Stopping a Window in which the First Node Receives the Synchronization Information

In another embodiment, after the first node starts the window (such as a ra-Response window), the first node can stop running the window after one or more of following conditions are met:
Condition 1: the above “first response message” is received from the target cell or candidate cell
Condition 2: the above “first response message” is received from the serving cell or the source cell
Condition 3: the first node transmits a random access signal in the target cell or candidate cell
Condition 4: the first node receives a signaling that triggers random access signal transmission in the serving cell or source cell, such as a PDCCH order

### Process of Response Messaging

If the information in the above “first response message” is generated by a distributed unit or base station where a cell (such as a target cell or candidate cell) that receives the random access signal transmitted/sent by the first node is located, when the above “first response message” is transmitted/sent by the above third node or the fourth node, before the above operation 1-5, at least one of following operations may further be included:

Operation 1-5a (not shown): the sixth node transmits the content in the above “first response message” to the second node, and then the second node transmits the received information to the third node

Operation 1-5b (not shown): the sixth node transmits the content in the above “first response message” to the fifth node, and then the fifth node transmits the received information to the second node, and then the second node transmits the received information to the third node

Operation 1-5c (not shown): the seventh node transmits the content in the above “first response message” to the fourth node

In addition to the information contained in the above “first response message”, in order to help the third node or the fourth node identify the user equipment (such as the first node) targeted by the information contained in the “first response message”, the first response message may also include at least one of following information:
User equipment identity information, such as a CU/DU F1AP UE ID, a XnAP UE ID, a C-RNTI, and the like.
Node identity information, such as a base station ID, a DU ID, and the like. The node identified by the information is a node that triggers the user equipment to synchronize, such as a node that triggers the user equipment to transmit a random access signal (such as a preamble) to the candidate cell through the PDCCH order
Synchronization configuration indication information, such as a configuration index, which indicates configuration used by the user equipment for synchronization. In one example, the information indicates configuration used for uplink synchronization, which is performed before the user equipment accesses the cell, such as a configuration index for early UL synchronization; specifically, a serving node of the current serving cell of the user equipment may transmit trigger information to the user equipment to trigger the user equipment to transmit synchronization information to a non-serving cell (such as a candidate target cell), and the configuration indicated by the information is configuration of the synchronization signal transmitted by the user equipment to the non-serving cell. Further, the indicated configuration may include at least one of following configurations: preamble configuration information, such as a preamble index, beam configuration information (such as an SSB/PBCH index), resource configuration information (such as random access occasion indication, a RACH occasion index), and carrier configuration information
System frame number information, which indicates a system frame number when the user terminal transmits an uplink synchronization related signal (such as a preamble). The information can help the third node or fourth node determine time when the user equipment transmits a synchronization signal
Preamble configuration information. The preamble is a preamble used for random access of the user equipment, such as a preamble index, a random access preamble identifier (RAPID)
Beam configuration information, such as an SSB/PBCH index
Resource configuration information. The resource is a resource used by the user equipment for synchronization. In one example, the resource is a resource used by the user equipment to perform random access (or transmit a random access preamble), such as an RACH occasion. The information may include at least one of following information:
Resource indication information, such as a RA-RNTI, i.e., a RA-RNTI-associated resource
Resource start symbol index
Resource start slot index. The start slot is a slot in a system frame
Resource frequency domain index
Indication of a carrier where the resource is located, such as a normal uplink carrier, a supplementary uplink carrier

When the above “first response message” is transmitted/sent by the above sixth node or seventh node, several possible implementations for transmitting the “first response message” are given below:
Implementation I: after receiving the random access signal transmitted/sent by the first node, the sixth node or the seventh node generates the information in the above “first response message” and transmits it to the first node
Implementation II: after receiving the random access signal transmitted/sent by the first node, the sixth node or the seventh node generates the information in the above “first response message” and transmits the above “first response message” at least once, so that the first node can receive the message; in one example, the transmission of the above “first response message” may continue until receiving the indication information of the first node accessing the target cell or candidate cell (such as the “first notification message” in operation 1-8 below); in another example, the transmission of the above “first response message” can continue until the end of the window (such as the ra-ResponseWindow) or the window has expired. In other words, when the window is still running, the sixth node or the seventh node can continuously transmit one or more “first response messages”
Implementation III: the sixth node or the seventh node transmits the above “first response message” after receiving the indication information that the handover command has been transmitted/sent. In an example, the above “handover command” is transmitted/sent by the third node to the first node, and the third node notifies the second node of the “indication information that the handover command has been transmitted/sent” (this information may further include the target cell or candidate cell identity information), and then the second node transmits the “indication information that the handover command has been transmitted/sent” to the sixth node; in another example, the above “handover command” is transmitted/sent by the third node to the first node, and the third node notifies the second node of the “indication information that the handover command has been transmitted/sent” (this information may further include the target cell or candidate cell identity information), and then the second node transmits the “indication information that the handover command has been transmitted/sent” to the fifth node, and the fifth node transmits the “indication information that the handover command has been transmitted/sent” to the sixth node; in another example, the above “handover command” is transmitted/sent by the fourth node to the first node, and then the fourth node notifies the seventh node of the “indication information that the handover command has been transmitted/sent” (this information may further include the target cell or candidate cell identity information)
Implementation IV: the sixth node or the seventh node transmits the above “first response message” before the time when the window (such as a ra-ResponseWindow) is about to end

### Behavior of the First Node for Maintaining the Synchronization Information

In addition, the first node may receive one or more “first response messages”, thereby acquiring synchronization information (such as timing advance information) of multiple target cells or candidate cells. The information in the multiple messages may be transmitted/sent by one message, or may be transmitted/sent by multiple messages. After obtaining the synchronization information, the first node will save the synchronization information. In this way, when the synchronization information of the target cell accessed by the first node has been acquired by the first node, (uplink) synchronization does not need to be performed when the first node accesses the cell. However, due to limitations of capability of the first node, the first node cannot store too much synchronization information (that is, it cannot store synchronization information of too many cells, or synchronization information of multiple cells cannot be obtained through the manner of triggering by the PDCCH order). The following possible implementations can be used to prevent the first node from saving too much synchronization information:
Implementation I: the network side configures the target cell or candidate cell that allows the first node to save synchronization information (uplink synchronization information, such as timing advance information), or configures a cell that allows the first node to perform a synchronization information acquisition process triggered based on the PDCCH order, such as a cell directed by the “first synchronization-related indication information” in the “first configuration message” in above operation 1-1, or a cell directed by the “third synchronization-related indication information” in the “first command message” in the above operation 1-3
Implementation II: the first node determines the cell whose synchronization information is removed or reserved according to the indications from the network side, such as indication through the “first storage-related indication information” in the “first configuration message” of the above operation 1-1, or through the “third storage-related indication information” in the “first command message” of the above operation 1-3
Implementation III: the first node determines the cell whose the synchronization information is reserved or the cell whose the synchronization information is removed on its own. In an example, when the first node needs to trigger a synchronization information acquisition process for a new cell (such as a synchronization information acquisition process triggered by a PDCCH order), if the number of cells whose synchronization information saved by the first node has reached the maximum capacity, then the first node will select a cell whose synchronization information is removed or a cell whose synchronization information is reserved. For example, a cell with shortest remaining valid time of synchronization information is removed, a cell with smallest signal quality (such as L1-RSRP) is removed, and so on

### 4) First Node Handover Process

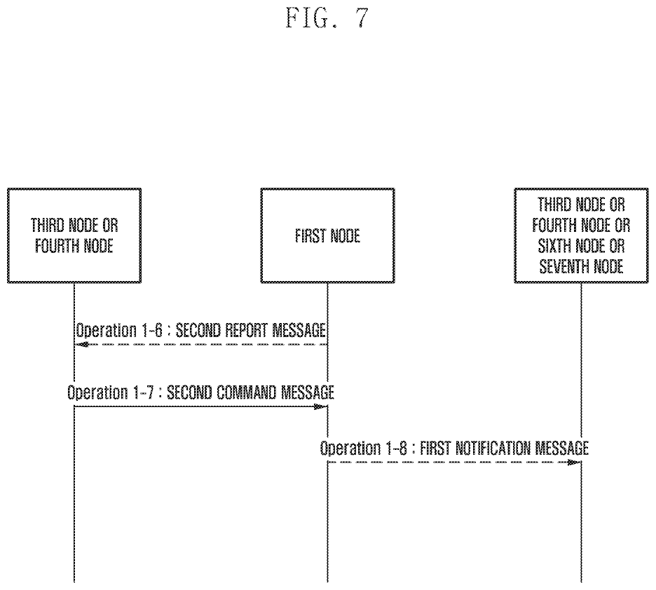

FIG. 7 is a flowchart of a handover process of the first node according to an embodiment of the disclosure.

After obtaining the synchronization information or when obtaining the synchronization information, the first node will hand over to the target cell according to the command from the network side, including following operations, as shown in FIG. 7:

Referring to FIG. 7, operation 1-6: optionally, the first node transmits a second report message to the third node or the fourth node, and a function of the message is to report the synchronization information obtained by the first node. For the specific content of this message, please refer to the above “first report message”.

The above second report message may be an L1 layer message, such as uplink control information (UCI), or a MAC CE, or an RRC message, or other types of messages.

Operation 1-7: the third node or the fourth node transmits a second command message to the first node. In an example, the second command message is the above handover command, such as an LTM command, an RRCReconfiguration, an RRC handover command. A function of this message is to indicate the first node to hand over to a target cell or a candidate cell. For the content contained in the message, please refer to the above “first command message”. In an example, the second command message may also include the information in the above “first response message”. In the case that the second command message includes the information in the “first response message”, the applicable cell indicated by the “first applicable information” therein is the target cell or the candidate cell.

Operation 1-8: optionally, the first node transmits a first notification message to the second node or the third node or the fourth node or the fifth node or the sixth node or the seventh node, and a function of the message is to notify the completion of the handover of the first node. The message may contain at least one of following information:
First access cell indication information, which indicates identity information of a cell accessed by the first node
First synchronization completion-related indication information, which indicates a cell whose synchronization information has been acquired by the first node; and the indication information may be identity information of one or more cells. After receiving this information, the network node can know for which cells the synchronization information (such as uplink synchronization information, timing advance information) has been acquired by the first node, and further, this information can also include a remaining valid time of synchronization information for each cell, which can help the network side know the valid time for the synchronization information of the first node. A beneficial effect of this information is to help the network side acquire synchronization status of the first node with other cells, and then help determine the target cell or candidate cell for subsequent handover, and accelerate the handover process
First synchronization execution-related indication information, which indicates a cell to which the first node has transmitted/sent a random access signal; and the indication information may be identity information of one or more cells. After receiving the information, the network node can know to which cells the first node has transmitted/sent random access signals, and then can further acquire synchronization information of these cells, and consider these cells when selecting a target cell. A beneficial effects of this information is: to help the network side select a suitable target cell, accelerate the handover, and reduce communication interruption of the first node

The above first notification message may be an L1 layer message, such as uplink control information (UCI), or a MAC CE, or an RRC message, or other types of messages.

### Behavior of the First Node for Processing Synchronization Information

After the first node accesses the target cell, the first node also needs to process the synchronization information acquired thereby (such as downlink synchronization information, uplink synchronization information, timing advance information, and the like), and several possible implementations are given below:
Implementation I: deleting synchronization information of other cells, which are different from the cell accessed by the first node
Implementation II: reserving synchronization information of other cells until the synchronization information expires, such as a valid time of the timing advance information expires
Implementation III: reserving synchronization information of other cells according to the indication from the network side. In this implementation, the network side may transmit configuration information to the first node, which indicates a cell whose synchronization information needs to be reserved, such as the cell indicated by the above “second storage-related indication information” or “third storage-related indication information”
   5) Network Node Interaction Process (this Process can be Performed Before and/or at the Same Time as the Handover of the First Node)

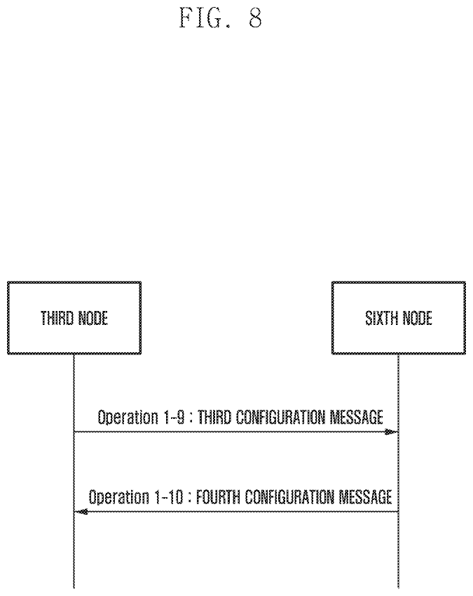

FIG. 8 is a flowchart of an interaction process between network nodes according to an embodiment of the disclosure.

There will also be information interaction between the third node and the sixth node, and the interaction can be conducted in the following ways, as shown in FIG. 8:

Referring to FIG. 8, operation 1-9: the third node transmits a third configuration message to the sixth node. The message indicates configuration information for the first node at the third node, which can help the sixth node configure the first node, and the message may include at least one of following information:
First synchronization-related indication information, which indicates a manner in which the first node is triggered to acquire synchronization information of a cell served by the sixth node. In one example, the manner is synchronization information acquisition triggered by a PDCCH order. For details, please refer to the above “first synchronization-related indication information”. According to this information, the sixth node can determine how to transmit the above “first response message” to the first node. For details, please refer to the above “behavior of the network side after receiving the random access signal”. Further, this information can also be used to indicate the random access signal transmitted/sent by the first node (one of the random access signals indicated by the above “first random access signal indication information” or “second random access signal indication information” or “third random access signal indication information”)
First waiting time indication information, which indicates waiting time required for the first node to acquire synchronization information. For details, please refer to the above “first waiting time indication information”
First window indication information, which indicates a length of a window in which the first node receives the synchronization information (such as uplink synchronization information, timing advance information), that is, the first node will only receive synchronization information within the time indicated by the information. For details, please refer to the above “first window indication information”
Fifth synchronization-related indication information, which indicates a cell to which the synchronization information stored by the first node belongs, such as cell ID or a cell to which the random access signal transmitted/sent by the first node belongs, or indicates whether the third node has transmitted/sent the synchronization information related to the sixth node to the first node. A beneficial effect of this information is: to help the sixth node to know the synchronization information acquired by the first node, which facilitates the sixth node to select a target cell for subsequent handover, reducing handover interruption
Fourth interval indication information, which indicates a length of a window in which the third node transmits a handover command, that is, the third node will transmit the handover command to the first node within this window, and further, the length of the window may also be used to help the sixth node configure an uplink resource used by the first node after accessing the target cell, for example, the uplink resource need to be configured after the window ends. A beneficial effect of this information is: to help the network side configure the uplink resource of the first node and avoid waste of resources
First command transmission indication information, which indicates that the handover command has been transmitted/sent to the first node, or indicates that the first node has received the handover command, or indicates that the first node has accessed a target cell or a candidate cell. After receiving the information, the sixth node can determine an occasion for transmitting the “first response message” to the first node. A beneficial effect of this information is: to help the sixth node to determine the occasion for transmitting synchronization information, ensure that the first node obtains synchronization information in time, and accelerate handover

Operation 1-10: the sixth node transmits a fourth configuration message to the third node, the message indicates configuration information about the first node at the sixth node, which can help the third node configure the first node, and the message can include at least one of following information:
First access configuration information, which indicates configuration information required for the first node to access a cell of the sixth node, and the information may include at least one of following information (for details, please refer to the description in the above “first configuration message”):
First cell identity information
First configuration identity information
First configuration information
First waiting time indication information, which indicates waiting time required for the first node to acquire synchronization information. For details, please refer to the above “first waiting time indication information”
First window indication information, which indicates a length of a window in which the first node receives the synchronization information (such as uplink synchronization information, timing advance information), that is, the first node will only receive synchronization information within the time indicated by the information. For details, please refer to the above “first window indication information”
Sixth synchronization-related indication information, which indicates a cell to which the synchronization information stored by the first node belongs, such as cell ID, or a cell to which the random access signal transmitted/sent by the first node belongs, or indicates whether the sixth node has transmitted/sent synchronization information to the first node. A beneficial effect of this information is: to help the third node know the synchronization information acquired by the first node, so that the third node can select a target cell for subsequent handover, and reduce handover interruption
Fifth interval indication information, which indicates a length of a window in which the sixth node expects the third node to transmit the handover command, that is, expects the third node to transmit the handover command to the first node within the window, and further, the length of the window is an interval length determined by the sixth node after configuring the uplink resource used by the first node in the target cell. If the third node transmits the handover command to the first node within the interval of the window, the uplink resource allocated by the sixth node to the first node can be effectively used. A beneficial effect of this information is: to help the network side determine the occasion for transmitting the handover command to the first node, and avoid waste of resources
First response message, which includes synchronization-related information provided by the sixth node to the first node. For the specific content of this information, please refer to the information in the above “first response message”. In an example, the first response information is a container including the above “first response message”. After receiving the information, the third node may transmit the information to the first node, thereby helping the first node acquire the synchronization information. A beneficial effect of this information is to help the first node acquire the synchronization information and reduce handover latency

A process of signaling interaction between the third node and the sixth node in the above operation 1-9 or operation 1-10 may include following possible implementations:
Implementation I: the third node interacts directly with the sixth node
Implementation II: when both the third node and the sixth node are connected to the second node, the third node and the sixth node can interact through the second node, for example, the sixth node transmits the fourth configuration message to the second node, and then the second node transmits the fourth configuration message (or the fifth configuration message; for information contained in the fifth configuration message, please refer to the description of the “fourth configuration message”) to the third node
Implementation III: when the third node and the sixth node are respectively connected to the second node and the fifth node, the third node and the sixth node can interact through the second node and the fifth node

In another embodiment, the content in the fourth configuration message transmitted by the sixth node to the third node can be transmitted in different operations, for example, in operation a, the information contained in the fourth configuration message transmitted by the sixth node to the third node includes at least one of following information: the first access configuration information, the first waiting time indication information, the first window indication information, the sixth synchronization-related indication information, and the fifth interval indication information. In one example, the information is used to indicate the configuration information required for the first node to access the candidate cell. Then, in operation b, the sixth node transmits the fourth configuration message to the third node. In this operation, the fourth configuration message includes the first response information, which is used to provide synchronization-related information (such as timing advance information) to the third node, thereby helping the third node trigger a cell handover of the first node.

### Acquisition and Configuration of Random Access Resource

In order to acquire the uplink synchronization information (such as timing advance) of the candidate cell or target cell, the first node needs to transmit a random access signal to the candidate cell or target cell. In the disclosure, the first node can acquire the uplink synchronization information of the candidate cell or target cell in two different implementations:

Implementation 1: acquiring uplink synchronization based on the non-random access process or acquiring uplink synchronization in advance (early UL synchronization). This implementation may be named as RACH-less, early UL synchronization, early UL TA acquisition, and the like.

In this implementation, after receiving the first indication information (such as a PDCCH order) from the serving cell, the first node transmits a random access signal to the candidate cell or target cell, and then acquires the uplink synchronization information of the above candidate cell or target cell through the signaling of the serving cell (such as the above-mentioned LTM command, RRCReconfiguration, RRC handover command).

Implementation 2: acquiring based on the random access or CFRA process. This implementation may be named as RACH-base, CFRA based, and the like.

In this implementation, after receiving the second indication information (such as the above-mentioned LTM command, RRCReconfiguration, RRC handover command) from the serving cell, the first node transmits a random access signal to the above target cell or candidate cell, and then acquires the uplink synchronization information of the cell from the above target cell or candidate cell. This implementation differs from the implementation 1 in that after transmitting the random access signal, the first node also needs to continue with other operations in the random access process (such as receiving the random access response message), and the uplink synchronization information is transmitted to the first node by the target cell or the candidate cell (while in the implementation 1, the uplink synchronization information of the target cell or candidate cell is transmitted to the first node by the serving cell).

In the above two implementations, the first node receives from the serving cell the indication information (such as the first indication information, the second indication information) that triggers the transmission of the random access signal. Thus, the base station or distributed unit where the serving cell is located needs to know the configuration information of the random access signal used in the above two different implementations. In order to achieve this goal, the disclosure provides the following process to acquire the configuration information of the random access signal. The process involves the following nodes.
A first node: a user terminal device, which can be a mobile phone, or a relay node
A second node: a central unit of a base station, or a control plane portion of the central unit of the base station
A third node: a distributed unit of a base station. In one example, the node is a distributed unit where the source cell (serving cell) of the first node is located during the movement
A fourth node: a base station. In one example, the node is a base station where the source cell (or serving cell) of the first node is located during the movement
A fifth node: a central unit of the base station, or a control plane portion of the central unit of the base station. When the first node moves between base stations, the fifth node is the node where the target cell or candidate cell is located
A sixth node: a distributed unit of the base station. In one example, the node is a distributed unit where the target cell (candidate cell) of the first node is located during the movement
A seventh node: a base station. In one example, the node is a base station where the target cell or candidate cell of the first node is located during the movement

The above fifth node and second node may be the same node, or may be different nodes.

When the base station includes a central unit and a distributed unit, the process includes the following operations:

Operation 2-1: the fifth node (or the second node) transmits a first request message to the sixth node. The function of this message is to prepare the target cell or candidate cell of the first node. The message will include information of the candidate cell or the target cell, and information related to a bearer of the first node. In addition, for a target cell or candidate cell, in order to acquire the information required by the first node when performing random access, the message may also include at least one of the following information:
Fourth cell indication information, which indicates information of a target cell or candidate cell accessed by the first node. The information may include at least one of the following information:
Fourth cell identity information, such as a PCI, a NCGI, an ECGI, cell index information, and the like.

Fourth synchronization-related indication information, which indicates a manner for triggering acquisition of synchronization information (such as uplink synchronization information, e.g., timing advance information) of the cell identified by the above-mentioned “fourth cell identity information”
Fourth cell type information, which indicates the type of the cell indicated by the above “fourth cell identity information”, for example, whether it is in the same distributed unit as the serving cell (source cell) of the first node (such as an intra-DU cell), or whether it is in a different distributed unit as the serving cell (source cell) of the first node (such as an inter-DU cell)
Fourth configuration identity information, such as a configuration ID, which indicates a configuration of the cell identified by the above-mentioned “fourth cell identity information”. Further, the configuration may be configuration information required by the first node for data transmission
First request indication information, which is used to request provision of configuration information of the random access signal used in the above “implementation 1”, such as Request for early UL/RACH-less/early TA acquisition RACH configuration, and the like.
Second request indication information, which is used to request provision of configuration information of the random access signal used in the above “implementation 2”
Third request indication information, which is used to request provision of configuration information of the random access signal used in the above “implementation 1” and “implementation 2”

Operation 2-2: the sixth node transmits a first response message to the fifth node. The function of this message is to provide configuration information of the target cell or candidate cell. In addition, for a target cell or candidate cell, the message may also include at least one of the following information:
Fifth cell indication information, which indicates information of a target cell or candidate cell accessed by the first node. The information may include at least one of the following information:
Fifth cell identity information, such as a PCI, a NCGI, an ECGI, cell index information, and the like.
Fifth configuration identity information, such as a configuration ID, which indicates a configuration of the cell identified by the above-mentioned “fifth cell identity information”. Further, the configuration may be configuration information required by the first node for data transmission
First request response information, which provides configuration information of the random access signal used in the above “implementation 1”. Information included in the information is configuration information used by the first node in the process of acquiring uplink synchronization information (such as timing advance information) in advance. The configuration information can be named as early UL synchronization configuration information, early TA acquisition configuration information, configuration information for a cell handover without random access (RACH-less cell switch configuration, i.e. a cell switch with RACH process omitted), and the like. The information includes at least one of the following information (for information contained in the following information, please refer to the description in the above “second configuration information”):
Frequency domain indication information
Time alignment timer
RACH-ConfigGeneric
RACH-ConfigDedicated
Second request response information, which is used to provide the configuration information of the random access signal used in the above “implementation 2”. The information included is the configuration information used by the first node to acquire synchronization information (such as timing advance information) through the random access process (or contention free random access process). The configuration information can be named as RACH-based configuration, contention free random access (CFRA) configuration, and the like. The information includes at least one of the following information (for information contained in the following information, please refer to the description in the above “second configuration information”):
Frequency domain indication information
Time alignment timer
RACH-ConfigGeneric
RACH-ConfigDedicated
Third request response information, which is used to request provision of the configuration information of the random access signal used in the above “implementation 1” and “implementation 2”. The information includes the above-mentioned “first request response information” and/or “second request response information”

The “first request response information”/“second request response information”/“third request response information” included in the above operation 2-2 may be provided based on the “first request indication information”/“second request indication information”/“third request indication information” in the above operation 2-1 respectively, or may be actively provided by the sixth node (e.g., operation 2-1 is not required).

The above-mentioned first request message and first response message may be a UE context setup/modification request message and a UE context setup/modification response message, respectively, or may be other messages.

Operation 2-3: the second node (when the fifth node and the second node are the same node, it can also be the fifth node) transmits a sixth configuration message to the third node. The function of this message is to provide configuration information of the target cell or candidate cell. For a configuration of transmission of the random access signal required by the first node, the message may include configuration information of at least one target cell or candidate cell. For a target cell or candidate cell, the message includes at least one of the following information:
Sixth cell indication information, which indicates the information of a target cell or candidate cell accessed by the first node. The information may include at least one of the following information:
Sixth cell identity information, such as a PCI, a NCGI, an ECGI, cell index information, and the like.
Sixth configuration identity information, such as a configuration ID, which indicates a configuration of the cell identified by the above-mentioned “sixth cell identity information”. Further, the configuration may be configuration information required by the first node for data transmission
Third configuration information, which provides configuration information of the random access signal used in the above “implementation 1”. Information included in the information is configuration information used by the first node in the process of acquiring uplink synchronization information (such as timing advance information) in advance. The configuration information can be named as early UL synchronization configuration information, early TA acquisition configuration information, configuration information for a cell handover without random access (RACH-less cell switch configuration, i.e. a cell switch with RACH process omitted), and the like. The information includes at least one of the following information (for information contained in the following information, please refer to the description in the above “second configuration information”):
Frequency domain indication information
Time alignment timer
RACH-ConfigGeneric
RACH-ConfigDedicated
Fourth configuration information, which is used to provide the configuration information of the random access signal used in the above “implementation 2”. The information included is the configuration information used by the first node to acquire synchronization information (such as timing advance information) through the random access process (or contention free random access process). The configuration information can be named as RACH-based configuration, contention free random access (CFRA) configuration, and the like. The information includes at least one of the following information (for information contained in the following information, please refer to the description in the above “second configuration information”):
Frequency domain indication information
Time alignment timer
RACH-ConfigGeneric
RACH-ConfigDedicated

The above-mentioned sixth configuration message may be a UE context modification request message, or may be other messages.

After the above operation 2-3, the third node may indicate the first node to transmit a random access signal according to different implementations. When the third node adopts the above “implementation 1”, the third node will transmit the first indication information (such as a PDCCH order) to the first node. The configuration of the random access signal indicated by the information is obtained according to the above-mentioned “third configuration information”. When the third node adopts the above “implementation 2”, the third node will transmit the second indication information (such as the above-mentioned LTM command, RRCReconfiguration, RRC handover command) to the first node. The configuration of the random access signal indicated by the information is obtained according to the above-mentioned “fourth configuration information”. Further, after the third node transmits the first indication information to the first node, if the third node does not obtain (from other nodes such as the second node, or the fifth node transmits it to the third node via the second node) the uplink synchronization information (such as timing advance information) required by the first node, the third node may transmit the second indication information to the first node, and indicate the first node to transmit the random access signal in the above “implementation 2” according to the above-mentioned “fourth configuration information”.

When the second node and the fifth node are different nodes, after operation 2-2, there is also included:

Operation 2-2a: the fifth node (or the seventh node) transmits a seventh configuration message to the second node (the fourth node). The message is used to transmit configuration information required by the first node to transmit the random access signal. The message may include configuration information of at least one target cell or candidate cell. For a target cell or candidate cell, the message includes at least one of the following information:
Seventh cell indication information, which indicates the information of a target cell or candidate cell accessed by the first node. The information may include at least one of the following information:
Seventh cell identity information, such as a PCI, a NCGI, an ECGI, cell index information, and the like.
Seventh configuration identity information, such as a configuration ID, which indicates a configuration of the cell identified by the above-mentioned “seventh cell identity information”. Further, the configuration may be configuration information required by the first node for data transmission
Fifth configuration information, which provides configuration information of the random access signal used in the above “implementation 1”. Information included in the information is configuration information used by the first node in the process of acquiring uplink synchronization information (such as timing advance information) in advance. The configuration information can be named as early UL synchronization configuration information, early TA acquisition configuration information, configuration information for a cell handover without random access (a RACH-less cell switch configuration, i.e. a cell switch with RACH process omitted), and the like. The information includes at least one of the following information (for information contained in the following information, please refer to the description in the above “second configuration information”):
Frequency domain indication information
Time alignment timer
RACH-ConfigGeneric
RACH-ConfigDedicated
Sixth configuration information, which is used to provide the configuration information of the random access signal used in the above “implementation 2”. The information included is the configuration information used by the first node to acquire synchronization information (such as timing advance information) through the random access process (or contention free random access process). The configuration information can be named as RACH-based configuration, contention free random access (CFRA) configuration, and the like. The information includes at least one of the following information (for information contained in the following information, please refer to the description in the above “second configuration information”):
Frequency domain indication information
Time alignment timer
RACH-ConfigGeneric
RACH-ConfigDedicated

The above-mentioned seventh configuration message may be a Handover request acknowledge message, or may be other messages.

The beneficial effect of the above process is that a network entity (such as the third node or the fourth node) where the cell serving the first node is located can acquire the configuration information required by the first node to acquire uplink synchronization information (such as timing advance information) in different implementations, so as to help the network entity indicate the first node to transmit the random access signal by using different manners, avoid resource conflicts and waste, and accelerate uplink synchronization of the first node.

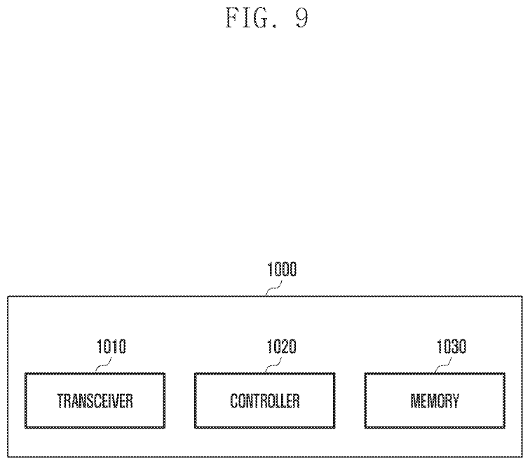

FIG. 9 is a block diagram of a node according to an embodiment of the disclosure. A node is taken as an example to illustrate its structure and function. However, it should be understood that the structure and function shown can also be applied to a base station (or a central unit of the base station, or a control plane portion of the central unit of the base station, or a user plane portion of the central unit of the base station, or a distributed unit of the base station, and the like).

Referring to FIG. 9, a node 1000 includes a transceiver 1010, a controller 1020, and a memory 1030. Under the control of the controller 1020 (which may be implemented as one or more processors), the node 1000 (including the transceiver 1010 and the memory 1030) is configured to perform the operations of the node described herein. Although shown as separate entities, the transceiver 1010, the controller 1020, and the memory 1030 may be implemented as a single entity, such as a single chip. The transceiver 1010, the controller 1020, and the memory 1030 may be electrically connected or coupled to each other. The transceiver 1010 may transmit a signal to and receive a signal from other network entities, such as another node and/or a UE, and the like. In one implementation, the transceiver 1010 may be omitted. In this case, the controller 1020 may be configured to execute instructions (including computer programs) stored in the memory 1030 to control the overall operation of the node 1000, thereby implementing the operations of the node described herein.

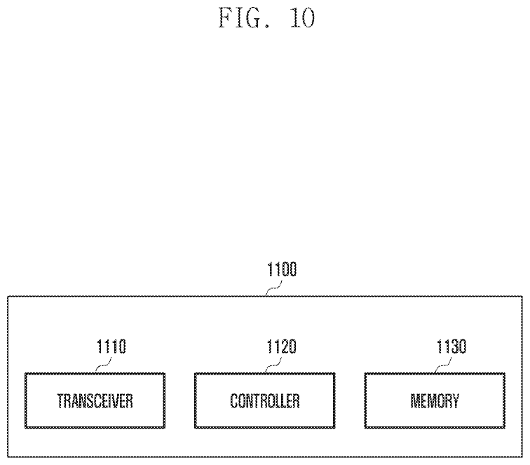

FIG. 10 is a block diagram of a user equipment according to an embodiment of the disclosure. In the disclosure, the terms “user equipment”, “user terminal device”, “user terminal”, and “terminal device” may be used interchangeably.

Referring to FIG. 10, a user equipment 1100 includes a transceiver 1110, a controller 1120, and a memory 1130. Under the control of the controller 1120 (which may be implemented as one or more processors), the user equipment 1100 (including the transceiver 1110 and the memory 1130) is configured to perform the operations of the user equipment described herein. Although shown as separate entities, the transceiver 1110, controller 1120, and memory 1130 may be implemented as a single entity, such as a single chip. The transceiver 1110, the controller 1120, and the memory 1130 may be electrically connected or coupled to each other. The transceiver 1110 may transmit a signal to and receive a signal from other network entities, such as a node, another UE, or the like. In one implementation, the transceiver 1110 may be omitted. In this case, the controller 1120 may be configured to execute instructions (including computer programs) stored in the memory 1130 to control the overall operation of the user equipment 1100, thereby performing the operations of the user equipment described herein.

Those skilled in the art may realize that the disclosure can be implemented in other specific forms without changing the technical idea or basic features of the disclosure. Therefore, it should be understood that the above embodiments are merely examples and not limitative. The scope of the disclosure is defined by the appended claims rather than the detailed description. Therefore, it should be understood that all modifications or changes derived from the meaning and scope of the appended claims and their equivalents fall within the scope of the disclosure.

In the above-described embodiments of the disclosure, all operations and messages may be selectively performed or may be omitted. In addition, the operations in each embodiment do not need to be performed sequentially, and the order of operations may vary. Messages do not need to be transmitted/sent in order, and the transmission order of messages may change. Each operation and transfer of each message can be performed independently.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. A method performed by a user equipment (UE) in a wireless communication system, the method comprising:
receiving, from a base station, a configuration message including layer 1/layer 2 (L1/L2) triggered mobility (LTM) candidate information associated with a LTM candidate cell, wherein the LTM candidate information includes first information on an early uplink (UL) synchronization procedure;
performing the early UL synchronization procedure with the LTM candidate cell based on the LTM candidate information;
performing a L1 measurement on the LTM candidate cell; and
transmitting, to the base station, a report message for the L1 measurement.

2. The method of claim 1, wherein the LTM candidate information further includes second information on a LTM candidate identifier (ID) and third information on a physical cell identity (PCI).

3. The method of claim 1, wherein the first information on the early UL synchronization procedure includes random access channel (RACH) configuration information for performing a random access procedure on the LTM candidate cell.

4. The method of claim 3, wherein the first information on the early UL synchronization procedure further includes information of an UL carrier for a random access preamble transmission on the LTM candidate cell.

5. The method of claim 1, further comprising:
receiving, from the base station, a LTM command via a media access control (MAC) control element (CE); and
switching to a target cell based on the LTM command.

6. The method of claim 5, wherein the LTM command includes timing advance (TA) information associated with the target cell.

7. A method performed by a base station in a wireless communication system, the method comprising:
transmitting, to a user equipment (UE), a configuration message including layer 1/layer 2 (L1/L2) triggered mobility (LTM) candidate information associated with a LTM candidate cell, wherein the LTM candidate information includes first information on an early uplink (UL) synchronization procedure;
receiving, from the UE, a random access preamble based on the LTM candidate information; and
receiving, from the UE, a report message for a L1 measurement.

8. The method of claim 7, wherein the LTM candidate information further includes second information on a LTM candidate identifier (ID) and third information on a physical cell identity (PCI).

9. The method of claim 7, wherein the first information on the early UL synchronization procedure includes random access channel (RACH) configuration information for a random access procedure on the LTM candidate cell.

10. The method of claim 9, wherein the first information on the early UL synchronization procedure further includes information of an UL carrier for a random access preamble transmission of the UE on the LTM candidate cell.

11. The method of claim 7, further comprising:
transmitting, to the UE, a LTM command via a media access control (MAC) control element (CE),
wherein the LTM command is for configuring the UE to perform a LTM cell switch procedure.

12. The method of claim 11, wherein the LTM command includes timing advance (TA) information associated with a target cell.

13. A user equipment (UE) in a wireless communication system, the UE comprising:
a transceiver; and
a controller configured to:
receive, from a base station via the transceiver, a configuration message including layer 1/layer 2 (L1/L2) triggered mobility (LTM) candidate information associated with a LTM candidate cell, wherein the LTM candidate information includes first information on an early uplink (UL) synchronization procedure,
perform the early UL synchronization procedure with the LTM candidate cell based on the LTM candidate information,
perform a L1 measurement on the LTM candidate cell, and
transmit, to the base station via the transceiver, a report message for the L1 measurement.

14. The UE of claim 13,
wherein the LTM candidate information further includes second information on a LTM candidate identifier (ID) and third information on a physical cell identity (PCI), and
wherein the first information on the early UL synchronization procedure includes random access channel (RACH) configuration information for performing a random access procedure on the LTM candidate cell.

15. The UE of claim 14, wherein the first information on the early UL synchronization procedure further includes information of an UL carrier for a random access preamble transmission on the LTM candidate cell.

16. The UE of claim 13,
wherein the controller is further configured to:
receive, from the base station, a LTM command via a media access control (MAC) control element (CE), and
switch to a target cell based on the LTM command, and
wherein the LTM command includes timing advance (TA) information associated with the target cell.

17. A base station in a wireless communication system, the base station comprising:
a transceiver; and
a controller configured to:
transmit, to a user equipment (UE) via the transceiver, a configuration message including layer 1/layer 2 (L1/L2) triggered mobility (LTM) candidate information associated with a LTM candidate cell, wherein the LTM candidate information includes first information on an early uplink (UL) synchronization procedure,
receive, from the UE via the transceiver, a random access preamble based on the LTM candidate information, and
receive, from the UE via the transceiver, a report message for a L1 measurement.

18. The base station of claim 17,
wherein the LTM candidate information further includes second information on a LTM candidate identifier (ID) and third information on a physical cell identity (PCI), and
wherein the first information on the early UL synchronization procedure includes random access channel (RACH) configuration information for a random access procedure on the LTM candidate cell.

19. The base station of claim 18, wherein the first information on the early UL synchronization procedure further includes information of an UL carrier for a random access preamble transmission of the UE on the LTM candidate cell.

20. The base station of claim 17,
wherein the controller is further configured to:
transmit, to the UE via the transceiver, a LTM command via a media access control (MAC) control element (CE),
wherein the LTM command is for configuring the UE to perform a LTM cell switch procedure, and
wherein the LTM command includes timing advance (TA) information associated with a target cell.
